(19) United States
(12) Patent Application Publication
(10) Pub. No.: US 2021/0192595 A1
(43) Pub. Date: Jun. 24, 2021

(54) Method For Web Address Agnostic Transaction Consolidating Multi-Merchant Purchases

(71) Applicant: Richard M Balan, Edmonton (CA)

(72) Inventor: Richard M Balan, Edmonton (CA)

(21) Appl. No.: 17/194,563

(22) Filed: Mar. 8, 2021

Related U.S. Application Data
(63) Continuation of application No. 15/915,248, filed on Mar. 8, 2018.
(60) Provisional application No. 62/469,737, filed on Mar. 10, 2017.

(51) Int. Cl. G06Q 30/06

(52) U.S. Cl. CPC G06Q 30/0625; G06Q 30/0633

(57) ABSTRACT

A series of associated merchant websites or respective merchant websites each selling narrowly defined product categories to shoppers who browse to select products for placement into a shopping cart. While each website is operated and controlled by a different merchant or a single merchant, each website has access to a shared server farm where information about each shopper is stored. Also shared is a virtual e-commerce shopping cart that the shopper can use to check out at any of the merchant websites even though the virtual e-commerce shopping cart may contain products from multiple different merchant websites. Each merchant website is associated with metadata limited to the narrowly defined product category, thereby providing enhanced SEO benefits without the need to purchase ad words. Each boutique specifically targets a single category making the shopping and buying experience easier. Information gathered from shoppers at each unique boutique is stored at the server farm for being shared with other associated merchants in the collection of sites. A shopper's user account will transfer between sites and allow the data gathered to be used in a cross-promotional method and will ensure the shopper's experience is consistent with what they like and want in future visits.

### RELATED APPLICATIONS

This application is a continuation of, and claims priority to, U.S. patent application Ser. No. 15/915,248, titled “Web Address Agnostic Transaction Consolidating Multi-Merchant Purchases”, which was filed in the USPTO on Mar. 8, 2018, and this application claims priority to U.S. Provisional Application Ser. No. 62/469,737, titled “Web Address Agnostic Transaction Consolidating Multi-Merchant Purchases”, which was filed in the USPTO on Mar. 10, 2017, both of which are incorporated herein by reference.

### FIELD

Implementations generally relate to electronic shopping, online shopping, or e-commerce, and more particularly relate to systems and methods enabling a shopper to enter search terms that are used to identify goods and services associated with or related to a common good or service, present to the shopper for selection and purchase only those goods and services that are associated with or related to the common good or service, which presented goods and services are being offered for sale by a variety of different merchants, or a single merchant with a network of connected sites, by way of rendering of corresponding displays to the shopper's browser by service of one or more webpages from each of the merchants' respectively different websites, allow the shopper to select from among the presented goods and services for placement in the shopper's virtual shopping cart, and then enable the shopper to conduct a single transaction to purchase all of the goods and services in the shopper's virtual shopping cart at the same time from a checkout procedure offered to the shopper from any one of the merchants' respective different websites.

### BACKGROUND

E-commerce is an effective, convenient and efficient way for shoppers to conduct transactions with merchants worldwide to buy goods and services. In prior art applications, the merchant having merchandise to offer typically implements a website at a merchant server, which may be maintained by the merchant's staff or hosted at a hosting facility. The merchant website typically includes a product database, representing the database of products to be sold, and a shopper database, representing the database of the merchant's shoppers and their respective profiles. To facilitate the transaction process, a variety of search, virtual shopping cart, and checkout tools may be provided. In general, these tools facilitate the interaction between a specific merchant website and the shopper. On the shopper's side, the interaction typically takes place through a software application installed on the user's computer device, or by way of an appropriate user interface at the shopper's computer terminal that may be executing a user interface in the form of a browser (e.g., Google Chrome, Microsoft Internet Explorer).

To facilitate discussion, FIGS. 1a-1b illustrate respective screen shots 102, 104 of a user interface of a prior art e-commerce arrangement between a browser operating on a consumer device and the vendor Amazon. To facilitate their electronic commerce activities, the interaction between the consumer and Amazon is facilitated through the shopper's computer terminal with which the shopper enters the URL (Universal Resource Locator) http://www.amazon.com to access that website with the browser, where the website and the shopper's computer terminal are connected to the World Wide Web. To conduct an e-commerce transaction with Amazon via the World Wide Web, the shopper typically utilizes a commercially available browser executing on the shopper's computer terminal.

An e-commerce application known as “My Garage” is shown in FIGS. 1a/1b. The My Garage application presented to the shopper is an aftermarket automotive parts shopping experience. In this experience, Amazon offers aftermarket automotive parts that are available for same either from Amazon or from a number of other merchants. In Amazon's approach, a single URL (e.g., //http:www.AMAZON.com) serves multiple webpages. Each webpage is limited to showing only those parts to the shopper that are specific to a particular make and model of a vehicle that the shopper has selected from a pull down menu shown in the list called “Your Garage” in FIG. 1a. This menu is populated only with automobiles specified as being owned by the shopper. As such, that the shopper only sees aftermarket automotive parts and accessories on webpages that are relevant to the shopper's aftermarket automotive parts search for a specific vehicle. By way of example, FIG. 1a shows the shopper selecting the “2015 Ford F-150” as the automobile for which aftermarket automotive parts are being sought for purchase from among the other vehicles shown in the pull down menu for “Your Garage”, and FIG. 1b shows the shopper having entered the search term “harness” with the result that the only products that are displayed for sale are harness automotive parts or accessories that are specifically designed to be aftermarket parts for the “2015 Ford F-150” automobile. Although Amazon offers automotive parts to the shopper that are available for sale from Amazon or from a number of other merchants, a limitation of Amazon's My Garage application is that the shopper is limited to only one (1) Amazon webpage where the shopper can purchase the goods and services in the shopper's electronic shopping cart.

FIG. 2 is a flowchart illustrating an exemplary prior art process for a shopper 202 to shop for multiple different goods and services and then conduct an electronic purchasing transaction at a website 204 by way of a check-out application 208 provided by a merchant that provides generic support functionalities 206. As shown in FIG. 2, a customer is provided with service in a traditional way in which the customer 202 visits “Site 1” 204, adds items into the customer's virtual shopping cart via website support 206, and the checks out of “Site 1” by way of checkout functionality 208 to purchase item(s) in the customer's virtual shopping cart. This prior art process is typical of an e-commerce merchant website that offers a particular type of good or service, and is presently what most users experience while using the Internet. A user visits a site and when they determine what they want to purchase. They then check out and purchase the items from the same e-commerce merchant website. Note, however, that data collected from the customer is not shared with any other merchant at any other merchant website. As such, each merchant's website at which the customer shops will be required to collect data from the customer and to provide the customer with a separate user experience varying from one merchant to another.

FIG. 3 illustrates a screen shot 300 characterizing an exemplary prior art user interface for the sale of floor liner parts for automotive vehicles at the merchant “Floor Liner Canada”. Note that the shopper can visit this webpage at this website to enter the customer's shipping address after adding multiple items into the shopper's electronic shopping cart, and thereafter the customer will pay for the items in the shopping cart for shipment to the customer-entered shipping address. Screen shot 300 can be used in conjunction with a typical user experience including but not limited to keyboard data entry, pull down menus, etc. Horizontal 318 and vertical 320 panning can be user activated to move that portion of the display that is being rendered horizontally and vertically, respectively.

Another prior art e-commerce arrangement is presented in US Patent Application Publication No. US US 2013/0133056 A1, which describes an e-commerce process for customers to conduct online shopping at multiple retailer websites using a single login identifier that allows prospective consumers to access various retailer websites on the Internet without the need to remember multiple logins and passwords or to log into such retailer websites each time the consumers uses a new electronic device. However, limitations of this prior art e-commerce arrangement are that the shopper is required to interact with third party vendors who are unrelated and unconnected, and the shopper is not provided with any vendor cross-selling capabilities among the vendors, each vendor website that the shopper visits requires a separate permission form the vendor, and the shopper is required to check-out via a third party at only one (1) website.

Yet another prior art e-commerce arrangement is presented in International Publication No. WO 01/01313 A2, which describes centrally implemented multi-vendor central processing unit acting cooperatively with a centrally implemented multi-vendor shared data store. In this prior art application, the e-commerce consumer is offered to make purchase selections from one of several different merchants, each selection being placed in a shared shopping cart to proceed to a shared, multi-vendor checkout, rather than implementing the checkout procedure at individual vendor websites. Also described is how each respective merchant website has access to a server farm (e.g., a Multi-Vendor Shared Data store) that includes a consumer database to track consumer profiles (i.e., shopper profiles) on behalf of the plurality of participating merchant websites. The information tracked by the consumer database for each consumer may include, for example, consumer personal information such as name, home address, phone number, payment method, and payment information (such as credit card information or deposit account information), as well as a unique shopper ID for uniquely identifying a consumer. The consumer profile for each consumer may also include a universal, cross-vendor virtual shopping cart into which items selected from a plurality of vendors may be deposited. However, limitations of this prior art e-commerce arrangement are that the vendors are required to be either co-operating vendors or the shopper is required to login with a password to an authentication system that is operated by a third party vendor. Also, the vendors are unrelated and unconnected and that, although the e-commerce application functions as a site or platform that allows the shopper to view third party products, the shopper is required to check-out at a only one (1) vendor server with a virtual shopping cart that navigates entirely to a third party vendor for the shopper's check-out.

In another prior art e-commerce arrangement that is presented in US Patent Application Publication No. US 2014/0122203 A1, a multi-merchant virtual shopping cart collects goods and services to be purchased by operation of a web browser. The shopping cart can be used at a plurality of unrelated merchant shopping sites and remains within the browser regardless of the displayed website. The user is also able to save products from a plurality of shopping sites to the shopping cart or purchase products from the shopping cart at one time. For each product to be purchased, a purchase transaction is conducted, on behalf of the user, with the merchant associated with the website from which the user added the product to the virtual shopping cart. This Publication also describes how the user is able to commence a purchase transaction for one or more products via the electronic shopping cart or save products from a plurality of unrelated merchant shopping sites to the virtual shopping cart for retrieval later. In certain cases, conducting a purchase transaction may include retrieving a user-saved address and payment information, providing the information to the merchant associated with the purchase transaction, receiving a purchase confirmation from the merchant, and communicating the purchase confirmation to the user. The user may elect to purchase at one time a single product, multiple products from a single merchant shopping site, or multiple products from multiple unrelated merchants shopping sites that are saved to the electronic shopping cart. For each product to be purchased, a purchase transaction is conducted, on behalf of the user, with the merchant associated with the supported website from which the user added the product to the electronic shopping cart. However, limitations of this prior art e-commerce arrangement include that it uses a website that has an overlay that is not built into, and is external to, other vendor websites. In addition, although the described website saves products from unrelated unconnected sites and vendors, the shopper is required to check out at the website of each vendor using an individual pass code and username for each vendor or an authorization style application. Further limitations include the requirement that the shopper be presented with separate and different user interfaces at each different website that are unrelated and operated by unrelated vendors

Yet another prior art e-commerce arrangement is presented in US Patent Application Publication No. US 2014/0244441, where an e-commerce shopping cart is described that is shared by multiple merchants, where the cart is a persistent cart of products online. The multi-merchant shared e-commerce virtual shopping cart can have products from a single vendor or from a variety of different vendors. However, limitations of this prior art e-commerce arrangement are that it functions like a plug-in for a third party e-commerce browsing site where all of the vendors are unrelated and where the shopper is required to use a check-out that is either an external vendor website or a third party partner website.

In another prior art e-commerce arrangement that is presented in U.S. Pat. No. 6,101,482, a customer chooses an item (e.g., a product or service) for subsequent purchase by putting each item in a virtual shopping cart via a Web browser that browses each of several different Web virtual stores. The virtual shopping cart is maintained across multiple independent transaction sessions across heterogeneous websites each of which corresponds to a different merchant. The shopper is able to suspend a purchasing decision about any item in the virtual shopping cart while comparison shopping across unaffiliated merchant websites before making a decision about which products in the virtual shopping cart to buy. However, limitations of this prior art e-commerce arrangement are that it functions like a plug-in for a third party e-commerce browsing site, the requirement that multiple different servers must be used, that all of the vendors and their respective websites are unrelated, the requirement that the shopper use separate logins for each vendor website in order to check-out, and the requirement that the shopper use a check-out that is either an external vendor website or a third party partner website.

One known limitation in prior art e-commerce applications is the necessity to purchase one or more ‘ad words’ in order to attract commercial traffic to an e-commerce website. This ad service is largely focused on keywords that are ‘sold’ to operators of e-commerce websites at which goods and sales are offered for sale that are associated with or related to the keywords that are sold by the ad service to the operators of e-commerce websites. By way of example, an ‘ad word’ can be sold as an advertising service to businesses that wants to display advertisement on a search engine's results and the search engine's advertising network (e.g., the Google search engine). This advertising service enables businesses to set a budget, which can be prohibitively expensive, for advertising and pay when people operate browsers to click the ads corresponding to the ad words sold to the business by the advertising service.

Given the above and other numerous problems imposed upon shoppers and merchants in prior art electronic shopping systems and methods, it would be an advance in the relevant arts to provide methods and systems that: (i) allow the shopper to use any one of several different merchant websites to check-out so as to purchase the selected goods and services in the shopper's virtual shopping cart that the shopper selected from any of the several different merchant websites; (ii) allow merchants to collect shopper data that can be shared with any other merchants' websites so that any merchant will have cross-selling capabilities among the merchants; (iii) allow the shopper to avoid interacting with third party vendors, such as when performing an electronic checkout function with the shopper's virtual shopping cart, where the vendor are unrelated and unconnected; (iv) allow the shopper to shop with different merchants at different webpages without requiring the shopper to use a separate permission or log-in for each different merchant; and (v) to avoid and reduce the need to purchase ‘ad words’ in order to attract commercial traffic to the e-commerce website. The collection of affiliated and associated sites creates a conglomerate under an umbrella site that creates benefits for the users and the business (merchant-members) because of the connectivity and the sharing of data and rich user information.

### SUMMARY

In one computerized implementation, a customer operates a web browser to select and place into a virtual shopping cart goods and/or services from a plurality of different merchant e-commerce websites, where each merchant e-commerce website is a boutique that offers for sale a specialized, limited and focused offering of goods and/or services, where each merchant e-commerce website features search engine discoverable metadata identifying the specialized, limited and focused offering of goods and/or services, and where customer can check-out to purchase the contents of the virtual shopping cart in a single transaction at any of the merchant e-commerce websites so to make the single purchase transaction agnostic as to the web address of the merchant e-commerce website at which the single purchase transaction was conducted by the customer.

In another computerized implementation, a series of respective merchant websites each sell narrowly defined product categories to shoppers who browse to select products for placement into a shopping cart. While each website is operated and controlled by a different merchant or a single merchant with a network of specialized sites, all websites have access to a shared server farm where information about each shopper is stored. Having a conglomerate of sites under the umbrella will provide a user greater access to products of interest because of the ease to create a collection of sites of similar interest for the user. The collection of sites under the umbrella will also create rich a collection of rich user data that can be repurposed for cross selling. Having the opportunity to repurpose this type of rich data will provide the affiliated and associated merchant sites with information to create a successful user experience. Also shared is a virtual e-commerce shopping cart that the shopper can use to check out at any of the merchant websites even though the virtual e-commerce shopping cart may contain products from multiple different merchants. Each merchant website is associated with metadata limited to the narrowly defined product category corresponding to the website, thereby providing enhanced Search Engine Optimization (SEO) benefits without the need to purchase advertising words. Each boutique specifically targets a single category. Information gathered from shoppers at each unique boutique is stored at the server farm or in cloud based storage for being shared with other associated merchants in the collection of sites under the umbrella site concept.

The shopper, by way of example pertaining to an automotive parts aftermarket collection of website, enters vehicle information at a first website where there may also be a creation of a user account and collection of further personalization information that will be used to guide the user to other products at other specialized websites pertaining to the vehicle or the user's interests entered by the shopper, thereby providing a specific boutique or specialized site shopping experience. This user account will transfer between sites and allow the data gathered to be used in a cross-promotional method and will ensure that the user's experience is consistent with what they like and want as to purchase offers in future visits.

### BRIEF DESCRIPTION OF THE DRAWINGS

FIGS. 1a-1b illustrate respective screen shots showing user interfaces for a prior art e-commerce arrangement between a browser-operating consumer and a vendor;

FIG. 2 is a flowchart illustrating an exemplary prior art process for a shopper to shop for multiple different goods and services and then conduct an electronic purchasing transaction at a website at a check-out application provided by a merchant by way of generic support functionalities;

FIG. 3 illustrates a screen shot 300 characterizing a prior art user interface for a customer to enter shipping data to be used for the sale of floor liner parts for automotive vehicles at a merchant;

FIG. 4 is a flowchart illustrating an exemplary process that affords Search Engine Optimization (SEO) enhancements provided by an umbrella site among a plurality of different e-commerce merchant websites; FIG. 4 is also an example of the associate and affiliate site concept which as a member of the umbrella site. This provides a benefit to both the merchant sites and the user.

FIG. 5 is diagram showing aspects of the Search Engine Optimization (SEO) enhancements provided by the umbrella site among the plurality of different e-commerce merchant websites shown in FIG. 4;

FIG. 6 illustrates a screen shot characterizing, inter alia, an exemplary user interface for a shopper to enter search terms pertaining to automotive parts and accessories, by way of a plurality of different pull down menus, in order to ensure that a search engine will select and present to the shopper only those automotive parts and accessories that pertain to the entered search terms, whereby the shopper can navigate to one or more specialty e-commerce merchant websites each presenting to the shopper only those automotive parts and accessories that pertain to the entered search terms; FIG. 6 is also an example of how both associated and affiliated sites become part of the conglomerate of sites under the umbrella of sites.

FIGS. 7-8 are respective flowcharts illustrating exemplary processes for a shopper to shop at only some or at all of a plurality of different e-commerce merchant websites, and then conduct a single e-commercial check-out transaction at any one of the different e-commerce merchant websites so as to purchase all of the of the items in the shopper's electronic shopping cart that were selected and put into the shopper's electronic shopping cart at only some or at all of a plurality of different e-commerce merchant websites;

FIG. 9 illustrates a screen shot characterizing a user interface for a customer to enter shipping data to be used for the sale of floor liner parts for the automotive vehicle pertaining to the search terms entered via the user interface of FIG. 6 for the shipment of the items in the shopper's electronic shopping cart that were selected and put into the shopper's electronic shopping cart at only some or at all of a plurality of different e-commerce merchant websites;

FIG. 10 illustrates a screen shot characterizing a user interface for a shopper to view the contents of shopper's electronic shopping cart which contains different items that the shopper selected and put into the shopper's electronic shopping cart at different e-commerce merchant websites;

FIG. 11 illustrates a screen shot characterizing a user interface for a shopper to enter shipping data to be used to ship the purchased contents of shopper's electronic shopping cart which contains different items that the shopper selected and put into the shopper's electronic shopping cart at different e-commerce merchant websites;

FIGS. 12-14 are respective flowcharts illustrating exemplary processes for a shopper to shop at only some or at all of a plurality of affiliated or associated e-commerce merchant websites, where the shopper has the ability to change information requested by one or more of the websites, and where the changed information is updated for use at and by any of the other plurality of different e-commerce merchant websites as the shopper is shopping;

FIG. 15 illustrates a screen shot characterizing a user interface for a customer to view floor liner parts for the automotive vehicle pertaining to the search terms entered via the user interface of FIG. 6, which floor liner parts are being offered for sale by a plurality of different e-commerce merchants;

FIG. 16 illustrates a screen shot characterizing a user interface for a customer to view truck cover parts for the automotive vehicle pertaining to the search terms entered via the user interface of FIG. 6, which truck cover parts are being offered for sale by a plurality of different e-commerce merchants;

FIGS. 17-18 are flowcharts illustrating exemplary processes in which account information pertaining to a shopper is stored in a network accessible database for use by only some or at all of a plurality of different e-commerce merchant websites. The data gathered will be used to provide value to the associate and affiliated connected sites to allow for a reduced quantity of advertising expense, such as S.E.O. ‘ad word’ expense due to the cross selling nature of being part of this community. The co-operative nature of the umbrella of sites creates an environment that provides benefits for merchants and users.

FIG. 19 illustrates a screen shot characterizing a user interface for the selection of which account information pertaining to a shopper, which information is stored in a network accessible database, and which information is to be shared over a network by select set of different e-commerce merchant websites; and

FIGS. 20-25 are flowcharts illustrating exemplary processes in which account information for each shopper is stored as profile data in a network accessible database for use by only some or at all of a plurality of different e-commerce merchant websites, where the profile data can be shared across the e-commerce merchant websites that are connected by way of a network so as to provide each shopper with a personalized shopping experience.

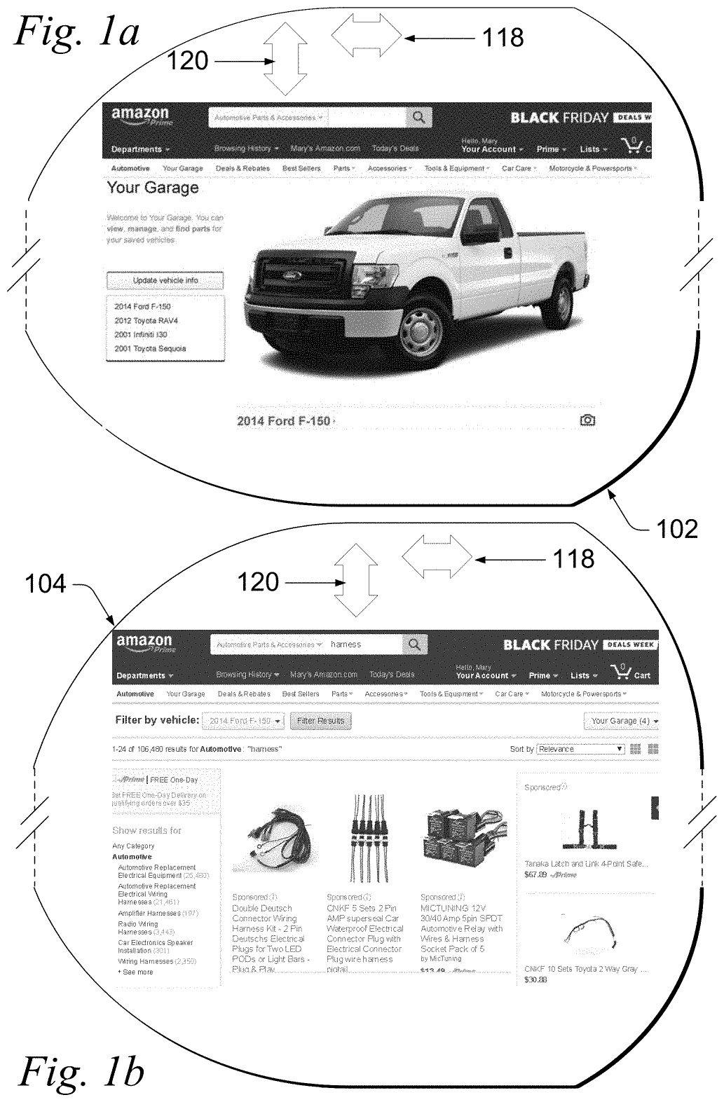

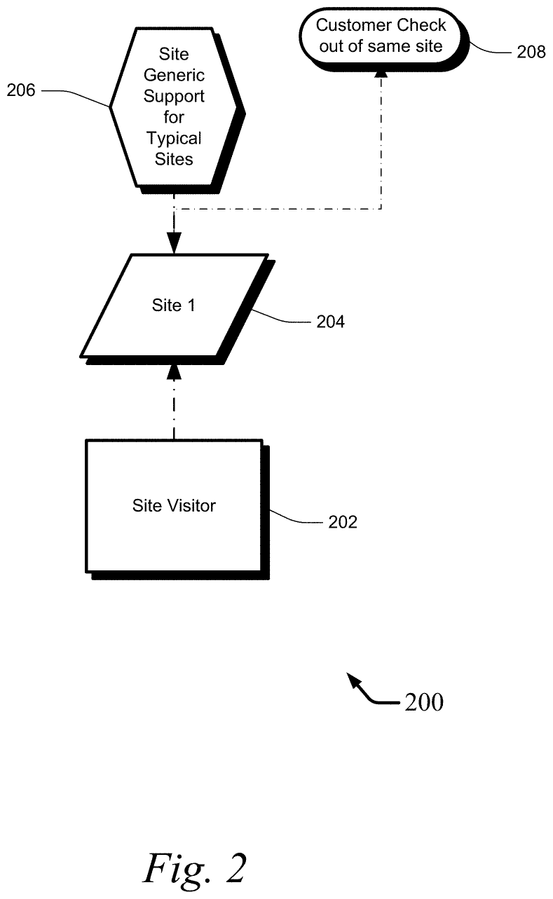

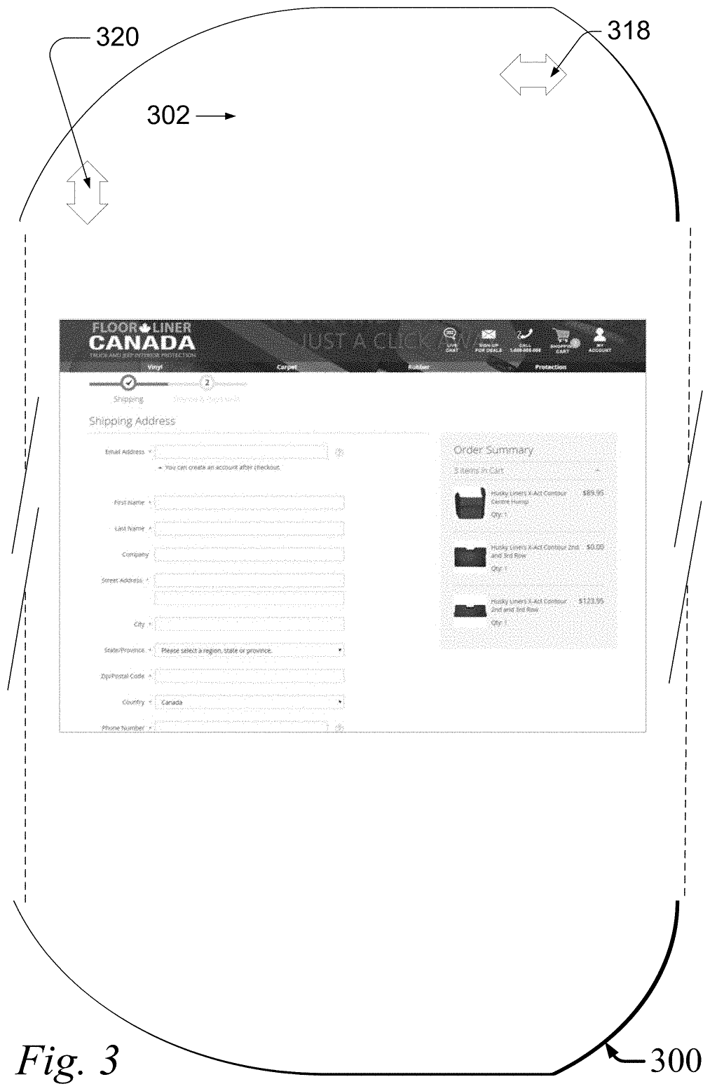

Implementations will become more apparent from the detailed description set forth below when taken in conjunction with the drawings, in which like elements bear like reference numerals.

### DETAILED DESCRIPTION

In a computerized implementation, a method enables a user over the World Wide Web (WWW) to interact and easily find products, simplify the user's session e-commerce shopping experience, provide information that is specific to the user's active request as to purchase interests, provide passive suggestions that are applicable to the user's active requests, acquire and share specific user profile information to ensure that the user has a personalized shopping experience, and to provide e-commerce merchants who offer goods and services to the user with enhanced Search Engine Optimization (SEO) benefits for the e-commerce merchants who are part of the network of sites.

The method of the computerized implementation provides a plurality of e-commerce speciality websites. Each e-commerce speciality website offers only a limited set of goods and services that are associated with or related to a common good or service. As such, when a shopper enters search terms directed to the common good or service, the shopper will be directed only to those e-commerce speciality websites that present to the shopper only those goods and services that are associated with or related to the common good or service. However, the presented goods and services that are offered for sale by a variety of different merchants, where each merchant operates a separate and distinct e-commerce speciality website.

The method of the computerized implementation provides a network of specialty e-commerce merchant websites through which the shopper is quickly and efficiently guided so as to provide the shopper with a shopping experience that is personalized to the data accumulated that pertains to the shopper and the shopping interests of that shopper. As such, the method of the computerized implementation provides a greater likelihood of optimized SEO benefits. The SEO benefits occur because each specialty e-commerce merchant website is associated search engine discoverable metadata that specifically targets a single category that can be matched to the data accumulated that pertains to the shopper and the shopping interests of that shopper, thereby providing the shopper with greater likelihood that the shopper is being presented with relevant and correlated specialty e-commerce websites at which textual, verbal, or artificial intelligence category experts can be offered to the shopper to improve the shopper's buying process.

Since each e-commerce speciality website offers only a limited set of goods and services that are associated with or related to a common good or service, and since each specialty e-commerce merchant website is associated search engine discoverable metadata that specifically targets a single category, there is a reduced need to purchase ‘ad words’ in order to attract commercial traffic to each specialty e-commerce merchant website. In practice, when a shopper enters search terms directed to the common good or service, the computerized method will provide multiple hits points that give each e-commerce merchant website a greater likelihood for organic search growth even though few or no ad word were purchased by the merchant for their e-commerce merchant website. Although a single boutique website isn't unique, uniqueness is found in the provision of a conglomerate of associated and affiliated speciality sites sharing a merchant cart under an umbrella, as well as in this provision of ease of use for the user and significant value for the connected sites. The umbrella site can provide a granular level or local community based site representation. This granular or local collection of sites under an umbrella allows smaller and local merchants to compete and survive under the face of a narrow quantity of site domination. The affiliate or associated speciality site concept improves the user experience and provides a platform for merchants to build a long term sustainable service and product offering. The umbrella site will provide an environment to compete with large sites that are eroding local and smaller merchants. It will also allow the affiliated and associated sites to pool local marketing dollars and reduce operating costs for the boutique members.

By way of example, and not by way of limitation, search engine discoverable metadata associated with a specialty e-commerce merchant website will be metadata that identifies a special category. One such category could be the category of automobile floor liners, another such category could be the category of automobile roof racks, another such category could be the category of automobile hitches, another such category could be the category of automobile truck covers, etc. Each good or service in each special category can be identified by inventory-related data, such as by way of a Vehicle Identification Number (VIN) or some portion thereof, a Global Trade Item Number (GTIN) that is used to uniquely identify items for sale, a Manufacturer Part Number (MPN) to identify a part with a series of numbers and/or letters given to that part by the manufacturer, a Universal Product Code (UPC) to uniquely identify a product, a part number provided by a manufacturers that uses an internal part number or a unique code to bundle parts where a plurality of parts are bundled together into an assembly for re-sale purposes, etc.

The linking together of the e-commerce merchant websites over the network allow for more effective targeting of the shopper and the shopper's interests. Also, this provides effective multi-site linkage among merchants or affiliates and associates that improves the shopper's experience with personalization while also assisting the shopper in locating items that are relevant only to the shopper's interests. The foregoing improves the network of e-commerce merchant websites in optimizing the likelihood that their respective goods and services will be discovered by algorithms in use by search engines (e.g., Google, Bing, Dog Pile, etc.), as well as improving its reputation among its shoppers. Thus, the method of the computerized implementation provides the likelihood of an increase in the number or inbound links from these search engines, and higher shopper response rates. It will also provide the umbrella sites to enjoy the benefits of shared data and optimization that will create an environment of success for its members. Through the benefits of shared data, the merchants will be able to collectively lower costs associated with the expense of ad words, advertising, and site optimization.

The method of the computerized implementation provides a significant improvement over the typical single specialty e-commerce merchant website where the shopper visits the site, determines what they want to purchase, and then checks out to purchase the items from the same site. Having the ability of a shared cart that transfers between each of the network connected specialty e-commerce merchant websites provides the user with an experience that is unique and helpful. This agnostic approach reduces consumer frustrations of finding an item of interest at a general site, and reduces the purchase time to only a few clicks or steps. The agnostic approach will also provide significant benefits for the collection of sites.

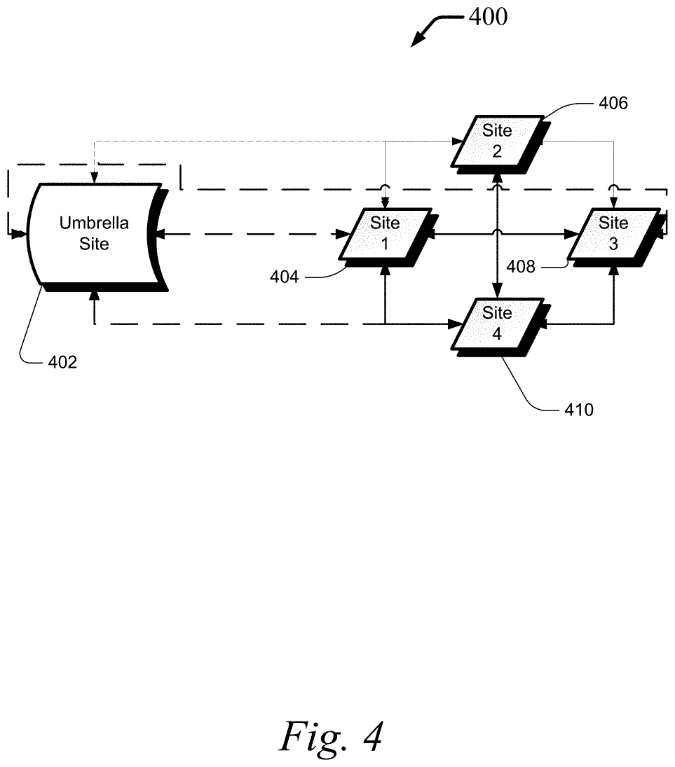

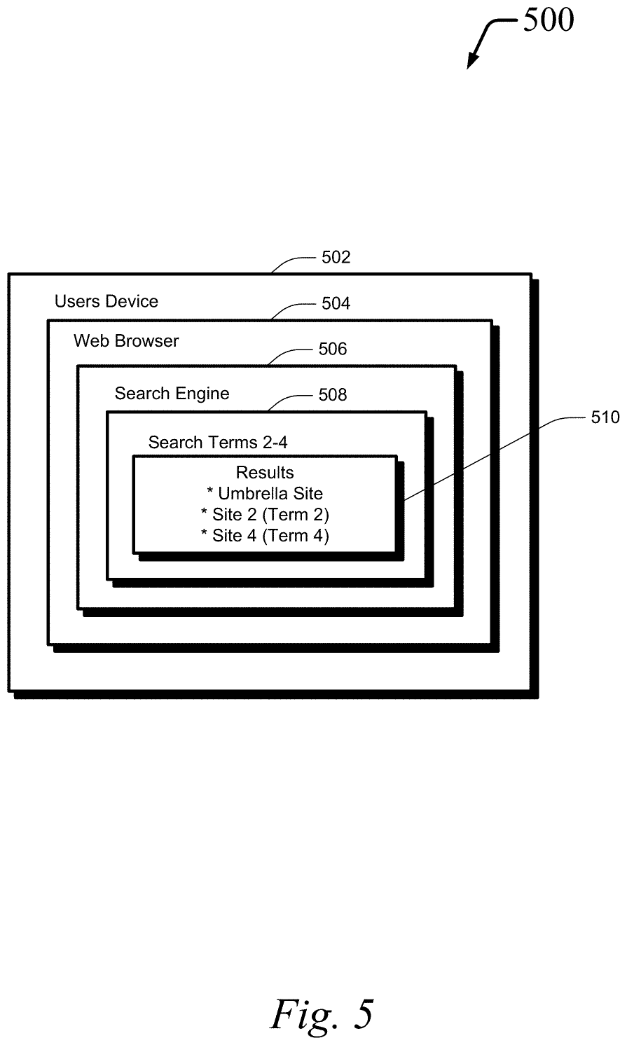

Referring now to FIGS. 4-5, a flowchart 400 illustrates a process that affords Search Engine Optimization (SEO) enhancements that are provided by an umbrella site 402 among four (4) e-commerce merchant websites 404-410. The flowchart 400 seen in FIG. 4 operates with components 500 illustrated in FIG. 5, including a user device 502, a web browser 504, a search engine 506, search terms 508 actively selected by the shopper, and search engine results 510 that are provided to e-commerce websites 404-410 depending upon the search engine discoverable metadata associate with each website.

The process seen in flowchart 400 provides a method for enabling users over the WWW to interact and easily find products, simplify a user's e-commerce shopping session experience, provide information that is specific, provide suggestions that are applicable to the shopper's original request, accumulate and store specific shopper profile information that ensures a specific experience for the shopper, and provide enhanced SEO benefits for the network of e-commerce merchant websites 404-408. Each e-commerce merchant website 404-410 is a specialty e-commerce merchant website that offers only a limited set of goods and services that are associated with or related to a common good or service. Since each specialty e-commerce merchant website 404-410 is associated search engine discoverable metadata that specifically targets a single category of or relating to the common good or service, there is a reduced need to purchase ‘ad words’ in order to attract commercial traffic to each specialty e-commerce merchant website 404-410.

In practice, when a shopper enters search terms directed to the common good or service, the computerized method, via umbrella site 402, will provide multiple hits points that give each e-commerce merchant website 404-410 a greater likelihood for organic search growth even though few or no ad words were purchased for each e-commerce merchant website 404-410. As such, the umbrella site 402 facilitates a multi-merchant network of specialty e-commerce websites that guide the user quickly and efficiently into sites 404-420 that are only relevant to the shopper and the shopper's interest, thus personalizing the shopper's shopping experience. Using a Specialty Site strategy will provide sites 404-410 a greater chance of SEO benefits. The SEO benefits occur because each Site 404-410 specifically targets a single category so as to provide the shopper the greatest comfort that they are dealing with category experts at each site 404-410 and more importantly making the buying process easier.

As shown in FIG. 4, the shopper traverses multiple web sites 404-410, entering and leaving each, to access, for example, aftermarket automotive parts offered for sale by respective different merchants at site 404-410, each e-commerce merchant website 404-410 allowing the shopping the ability to add a merchant's auto part for sale for a particular automobile make and model to a common virtual shopping cart that is shared by all participating merchants, and then allow the shopper to check out and make payment at any of the websites 404-410. As such, all participating merchants are paid by the single payment that is made at any of the websites 404-410. The computerized method thus facilitates the consolidation of all purchases being made by the shopper into one transaction from goods and services sold to the shopper by the four (4) merchants operating the four (4) sites 404-410.

The method of the computerized implementation enables web shoppers to actively selected search terms so that they interact and easily find products, simplify the shopper's browsing, shopping, and check-out session experience, provide information that is specific to the shopper's actively selected search terms, provides passive suggestions that are applicable to the shopper's actively selected search terms, enable the use of shopper-specific profile information that ensures a specific and personalized shopper experience, and provided enhanced SEO benefits for the network of sites 404-410.

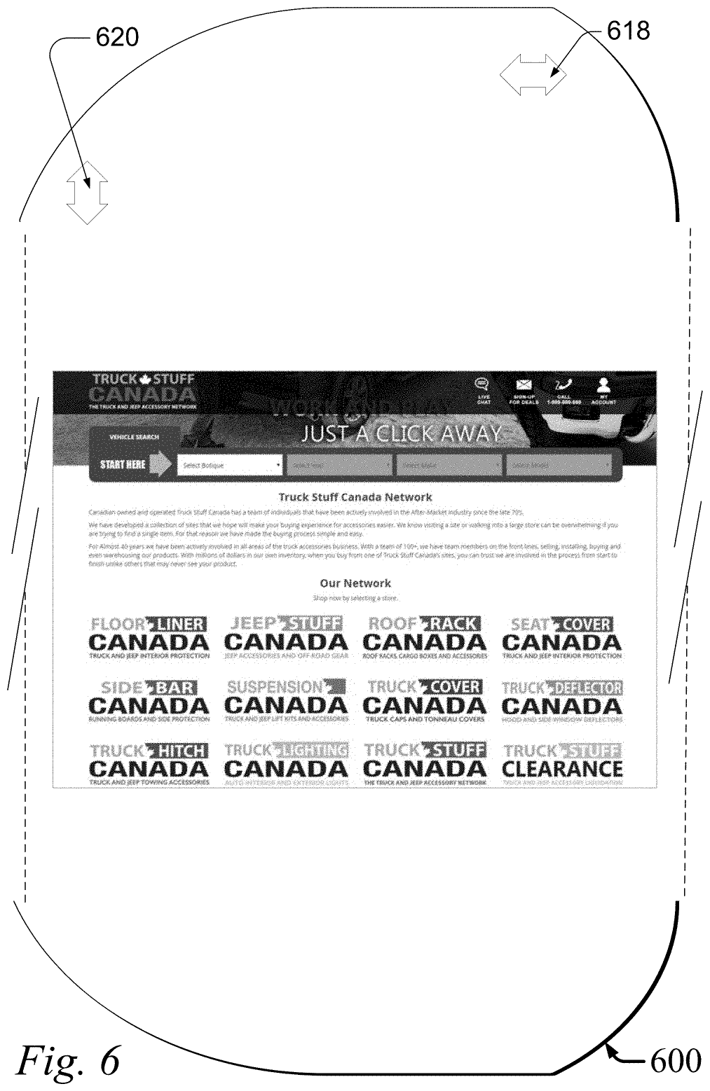

FIG. 6 shows screen shot 600 which can be a user interface where a shopper enters, via selections from pull down menus, search terms corresponding to the shopper's interests. Here, the shopper is interested in automotive parts and accessories for a particular make and model truck. As shown in FIG. 6, a plurality of different e-commerce websites, shown in the bottom of the screen shot 600, are possible websites to which the shopper will be directed depending upon the search terms that the shopper actively enters by way of selections from the pull down menus.

Note that each e-commerce websites shown in the bottom of the screen shot 600 will be associated with search engine discoverable metadata that is limited to those categories of goods and services directly identifiable to that website, for instance: (i) goods and services pertaining to automotive floor liners; (ii) goods and services pertaining to automotive jeep stuff; (iii) goods and services pertaining to automotive roof racks; (iv) goods and services pertaining to automotive seat covers; (v) goods and services pertaining to automotive side parts; (vi) goods and services pertaining to automotive suspension; (vii) goods and services pertaining to automotive truck covers; (viii) goods and services pertaining to automotive truck deflectors, goods and services pertaining to automotive truck hitches; (ix) goods and services pertaining to automotive truck lighting; (x) goods and services pertaining to automotive truck stuff on clearance sale, etc. Note, also, that the shopper can enter search terms pertaining to each of the foregoing categories by way of the shopper actively entering the same with selections from the pull down menus.

As the shopper searches for subject matter in accordance with the entered search terms, the computerised method will provide multiple hits points to give the networked merchants' websites, shown in the bottom of the screen shot 600, a greater chance for organic search growth—albeit without having to pay of ad words. In addition to targeting the shopper by sharing of the shopper's profile data among networked merchants' websites, an effective multi-site linkage is provided that improves the shopper's experience and assists the shopper in finding goods and services, improves the networked merchants' websites reputation with its shoppers, and optimizes the discoverability of the networked merchants' websites by search engines. From the foregoing, the networked merchants' websites are more likely to have more inbound links and higher response rates from their shoppers. With good information and a better selection of external links, the computerized method of networked merchants' websites provides SEO benefits which single sites cannot achieve.

In screen shot 600, horizontal 618 and vertical 620 panning can be user activated, such as by operation of a mouse or other pointing device for a graphical user interface, to move that portion of the display being rendered horizontally and vertically, respectively.

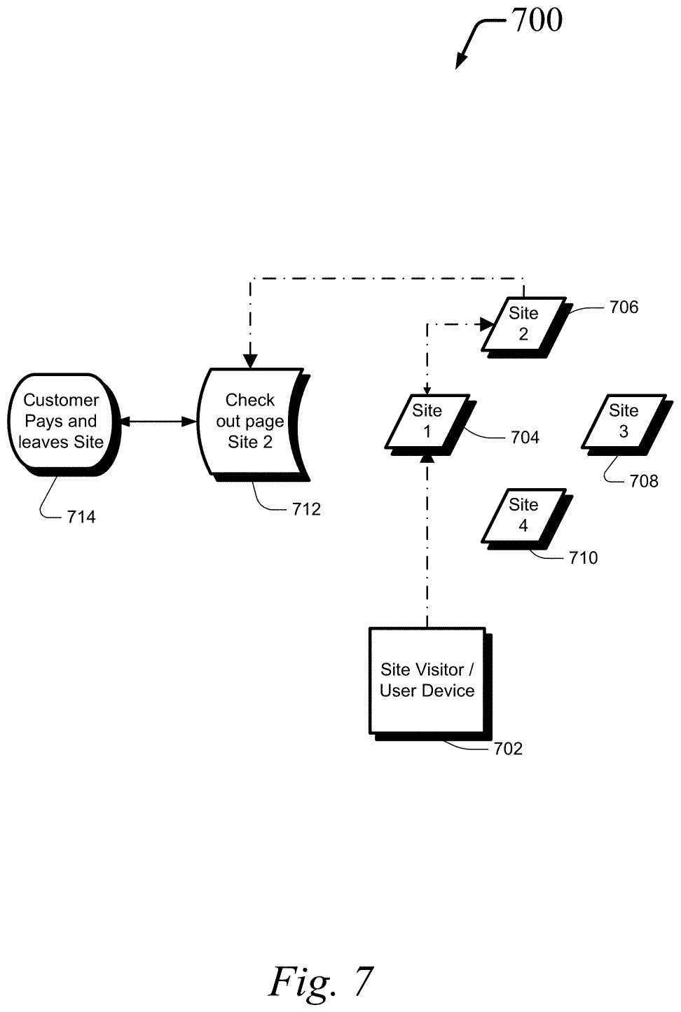

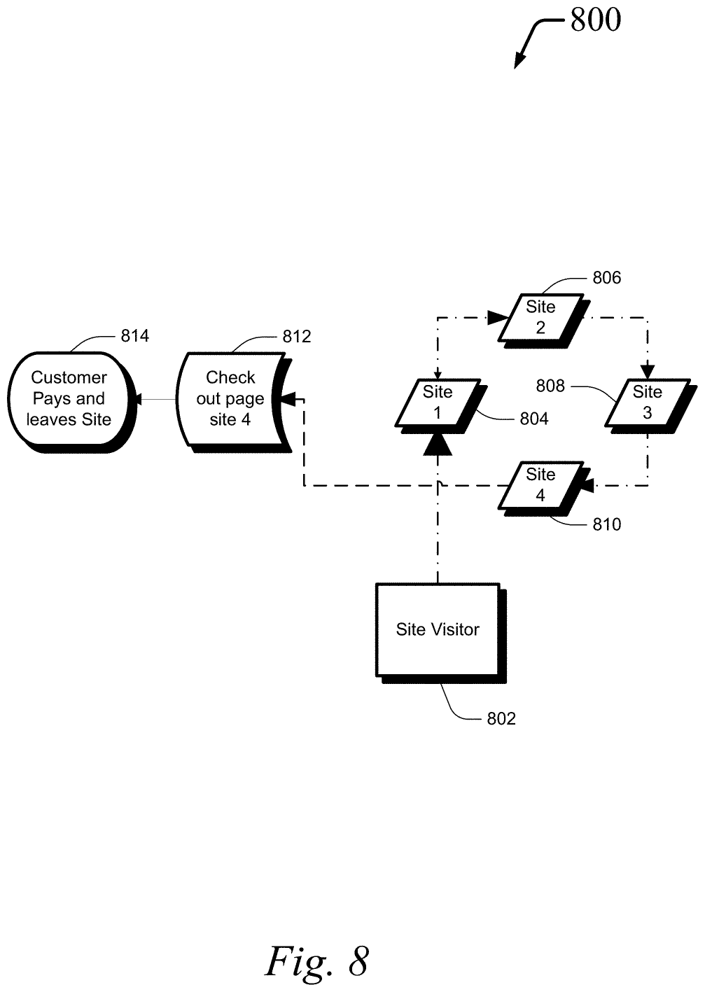

While conventional e-commerce merchant websites allow a user to visit the site, determine what they want to purchase, and then check-out to purchase the items from the same site, the computerized methods and systems disclosed herein provide the enhanced ability to have a shared electronic shopping cart that transfers between each of the connected networked merchants' websites so as to provide the shopper with an experience that is unique and helpful when visiting the networked merchants' websites. Referring to FIGS. 7-8, there are illustrated flowcharts 700-800 that illustrate shopper check-out processes for goods and services purchased at one more of networked merchants' websites 804-810. In FIG. 7, a site visitor 702, 802 uses device 702 to identify items they want to purchase and places them into an electronic shopping cart. The information is sent to an umbrella site (e.g., see Ref. Num. 402 in FIG. 4). When the user 702 visits site 706 they still have the items from site 704 in the cart, allowing the user to purchase items from site 704 and site 706 when at the check-out at process 712. This unique feature will also provide benefits to the member affiliate and associated sites that are part of the umbrella specialty site network.

FIG. 8 again provides a picture of how the shared virtual shopping cart works in the speciality site network. The user 802 visits sites 804 and then leaves the site 804 to visit website 806. The user identifies something they want and places the item into the virtual shopping cart. The user then goes to website 808 and again identifies something they want and places it into the cart. The user now has items from speciality websites 804 and 806. The user lastly visits site 810 and finds nothing, so they decide to check-out at website 810 with the items from sites 806-808. Having connected websites 804-810, the ease of being able to purchase between the websites 804-810 is not only possible but is easy and provides a unique experience in the specialty site network of e-commerce websites 804-810.

As shown in the process of flowchart 700, a customer visits merchant e-commerce website 704. The customer adds items into a virtual shopping cart from merchant e-commerce website 704. The customer leaves merchant e-commerce website 704 and visits merchant e-commerce website 706 during which the virtual shopping cart retains the items therein from merchant e-commerce website 704. The customer adds items into the cart from merchant e-commerce website 706 such that the virtual shopping cart retains the items therein from merchant e-commerce websites 704-706. Thereafter, the customer checks out at merchant e-commerce website 710 in a single transaction to purchase the items in the virtual shopping cart from merchant e-commerce websites 704-706 at website 710.

As shown in the process of flowchart 800, a customer 802 enters, visits, and leaves each of merchant e-commerce websites 804-810. The customer adds one or more items into the virtual shopping cart from two or more merchant e-commerce websites 804-810 such that the virtual shopping cart retains the items therein that selected from merchant e-commerce websites 704-710. When the customer 802 is shopping at any of the merchant e-commerce websites 804-810 the customer 802 can see the contents of the virtual shopping cart as to the quantity and pricing of items in the virtual shopping cart.

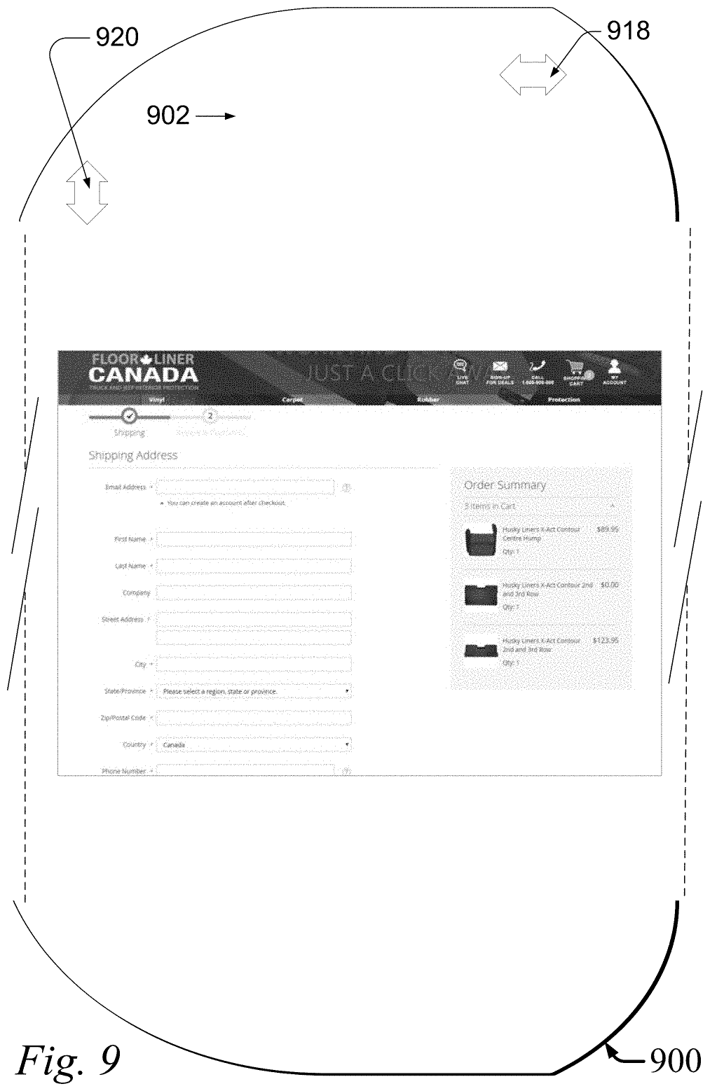

FIGS. 9-11 show screen shots 900, 1000, 1100 for respective user interfaces for a shopper using the networked e-commerce merchant websites 704-710 of FIG. 7 or the networked e-commerce merchant websites under the umbrella site which is a collection of both affiliated or associated members 804-810 of FIG. 8 to enter data. In FIG. 9, shipping data to be used for the sale of floor liner parts for the automotive vehicle pertaining to the search terms entered via the user interface of FIG. 9 for the shipment of the items in the shopper's electronic shopping cart that were selected and put into the shopper's electronic shopping cart at only some or at all of a plurality of different e-commerce merchant websites.

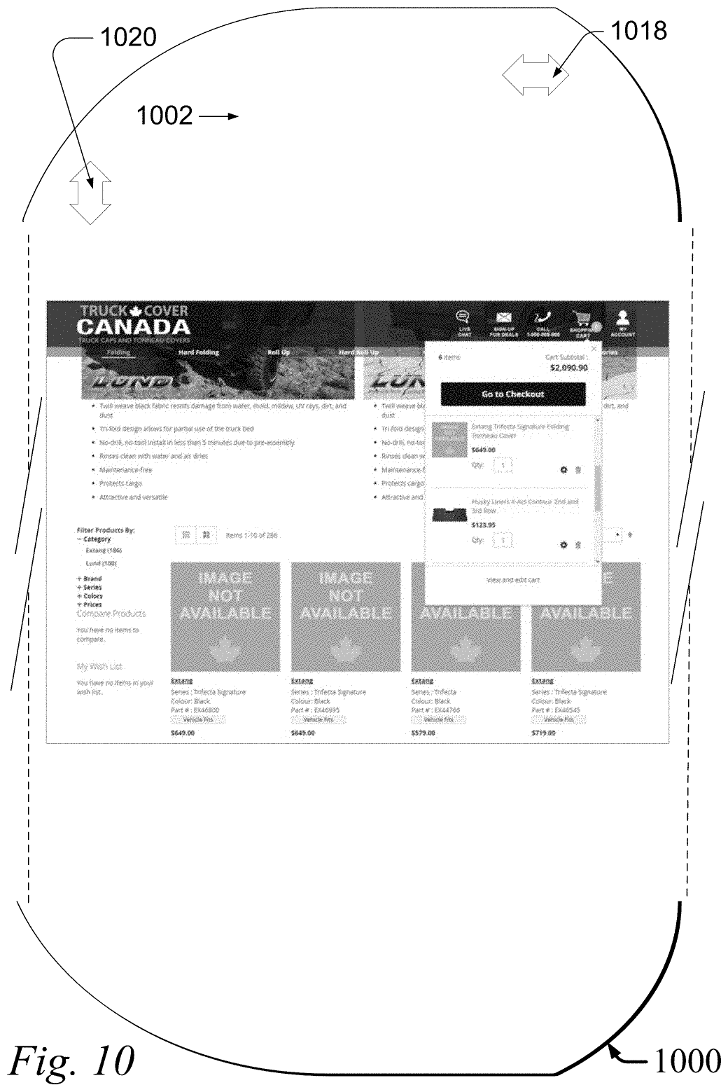

FIG. 10 illustrates a screen shot characterizing a user interface for the shopper to view the contents of shopper's electronic shopping cart, which contains different items that the shopper selected and put into the shopper's electronic shopping cart at different e-commerce merchant websites. Horizontal 1018 and vertical 1020 panning can be user activated to move that portion of the display being rendered horizontally and vertically, respectively.

In FIG. 10, a customer is shown to be visiting an automotive floor liner merchant e-commerce website where two (2) floor liners have been added to the virtual shopping cart. The customer then leaves the floor line merchant e-commerce website and goes to an automotive tonneau cover merchant e-commerce website to add two (2) more items to the virtual shopping cart. Note that parts added to the virtual shopping cart from the prior merchant e-commerce website remain in the shopping cart. Horizontal 918 and vertical 920 panning can be user activated to move that portion of the display that is being rendered horizontally and vertically, respectively.

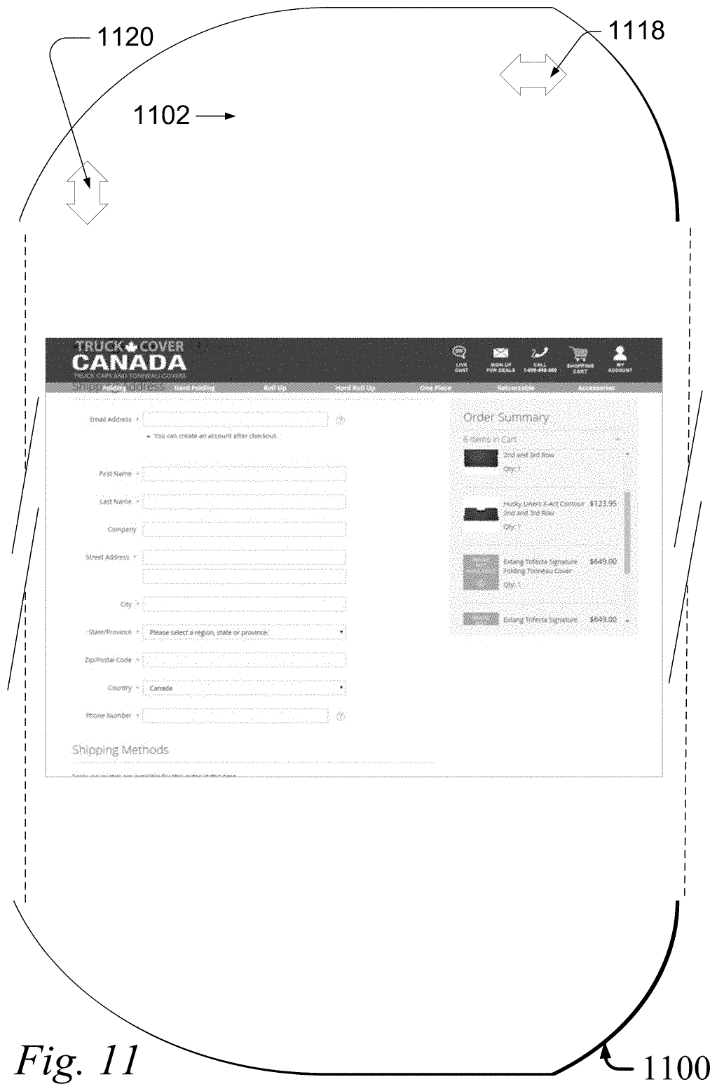

FIG. 11 illustrates a screen shot characterizing a user interface for the shopper to enter shipping data to be used to ship the purchased contents of shopper's electronic shopping cart as shown in FIG. 11 which contains different items that the shopper selected and put into the shopper's electronic shopping cart at different e-commerce merchant websites, where each website features goods and services in a category different than that of the other networked websites. In FIG. 11, an automotive truck cover merchant e-commerce website shows four items in the virtual shopping cart: two (2) items from an automotive floor liner merchant e-commerce website, and two (2) items from an automotive tonneau merchant e-commerce website. If the customer pays for all of the items in the virtual shopping cart at the automotive tonneau merchant e-commerce website, then the customer would receive an invoice from the automotive tonneau merchant e-commerce or the umbrella merchant's website even though some of the virtual shopping cart had items from the automotive floor cover merchant e-commerce website. Horizontal 1118 and vertical 1120 panning can be user activated to move that portion of the display being rendered horizontally and vertically, respectively.

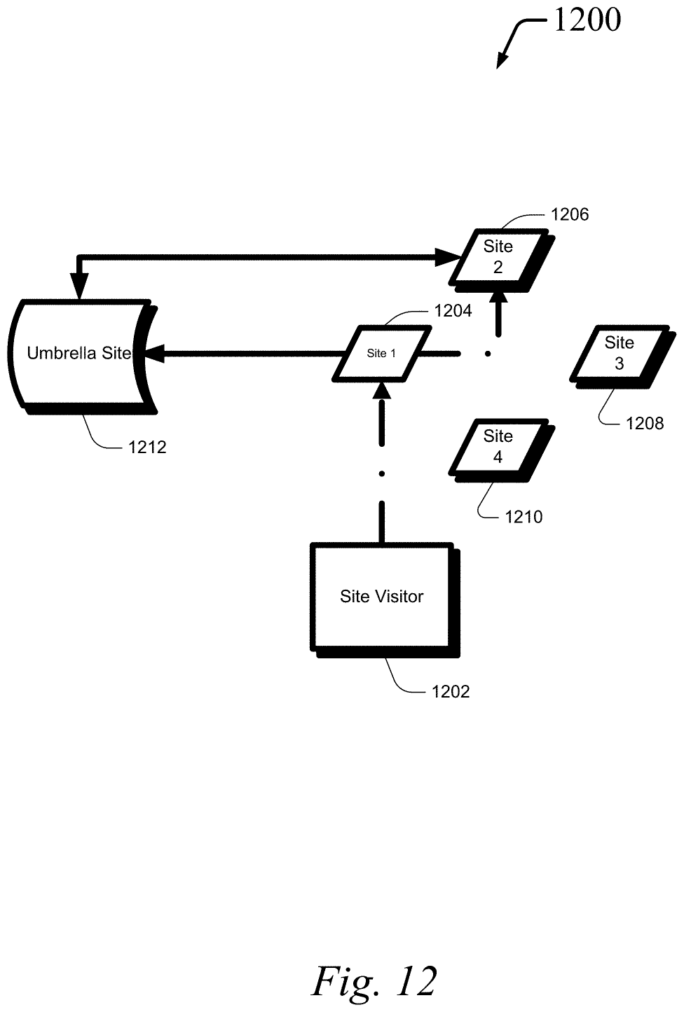

FIGS. 12-14 show flowcharts 1200, 1300 and 1400 illustrating respective exemplary processes that afford Search Engine Optimization (SEO) enhancements to shopper 1202, 1302, and 1402 provided by umbrella sites 1212, 1312, and 1412 among e-commerce merchant websites 1204-1210, 1304-1310, and 1404-1410. By way of example, each flowchart1200, 1300 and 1400 can operate with components similar to those at reference numeral 500 illustrated in FIG. 5, including a user device 502, a web browser 504, a search engine 506, search terms 508 actively selected by the shopper, and engine results 510 that are provided to various of the e-commerce merchant websites 1204-1210, 1304-1310, and 1404-1410, thereby enhancing the Web shopping experience and making the buying process easier for shoppers. Referring to FIG. 5 and FIGS. 12-14, nested processes 500 assist a user's use of a device 502 executing a web browser 504 to obtain results 510 from a search engine 506 with search terms 508 when shopping at the e-commerce merchant websites 1204-1210, 1304-1310, and 1404-1410.

Having multiple domain names connected to a single site creates additional touch points for a search engine to enable a user to find the network of e-commerce websites 1204-1210, 1304-1310, and 1404-1410, which is better and more effective that use of a sub/domain strategy. By linking the network of e-commerce websites 1204-1210, 1304-1310, and 1404-1410, there is an improvement in the user's experience, and the user is assisted in finding goods and services related to the user's search. This in turn improves the reputation of the network of e-commerce websites 1204-1210, 1304-1310, and 1404-1410 with users and search engines, resulting in more inbound links, and higher response rates. The multiple domain strategy will help make the buying and searching process easier for users across all ages because of its optimization strategy and ease of merchant specialized sites. The virtual cart that can travel between these connected boutiques will shift the user experience to a granular level which ultimately provides greater levels of user satisfaction and ease. The multiple domain strategy also creates a platform for affiliated and associated sites to work together by sharing data and site traffic which will provide significant value to both the user and the merchant members. It will also assist the merchant sites that are under the umbrella to pool marketing and expensive ad word purchases thereby reducing expenses for the participating merchants.

The processes illustrated in FIGS. 12-14 show how a user can shop in a session to view, select and purchase goods and services from different merchant e-commerce websites, each being a boutique that offers goods and services of a common or related category, so that the user is provided with a personalized experience by use of information that gathered from the user. Each boutique's or specialized merchant's website unique session experience gathers the user's information which is contained in the user's network assessable profile to provide the user advice regarding multiple products should they want to visit other merchant e-commerce websites or while checking out in a single multi-merchant transaction from the web address of a single merchant e-commerce website. This specialty or boutique merchant e-commerce website system also provides the user with a quick path to the items they are seeking or wanting thereby making the internet experience easier and buying goods quicker for the user.

When a user searches for a specific product, the collection of merchant e-commerce websites will bring them to a particular merchant e-commerce website, thereby significantly shortening the user's experience and thereby reducing the frustration of finding a specific product or service to meet the user's needs. Guiding the customer to the specific merchant e-commerce website target will shorten the search cycle and optimize the methodology of search on the Web. This unique benefit for the user will also provide a significant opportunity for the associated or affiliated members under the umbrella.

By way of example an aftermarket automotive collection of merchant e-commerce websites, after the user enters the automobile vehicle information into the first merchant e-commerce website during that session, the user can thereafter can visit any other merchant e-commerce website in a network thereof, and the information entered will be saved in a network accessible database, thereby ensuring that the information so collected will help the user find what the user is looking in a manner that is consistent across the entire network of merchant e-commerce websites

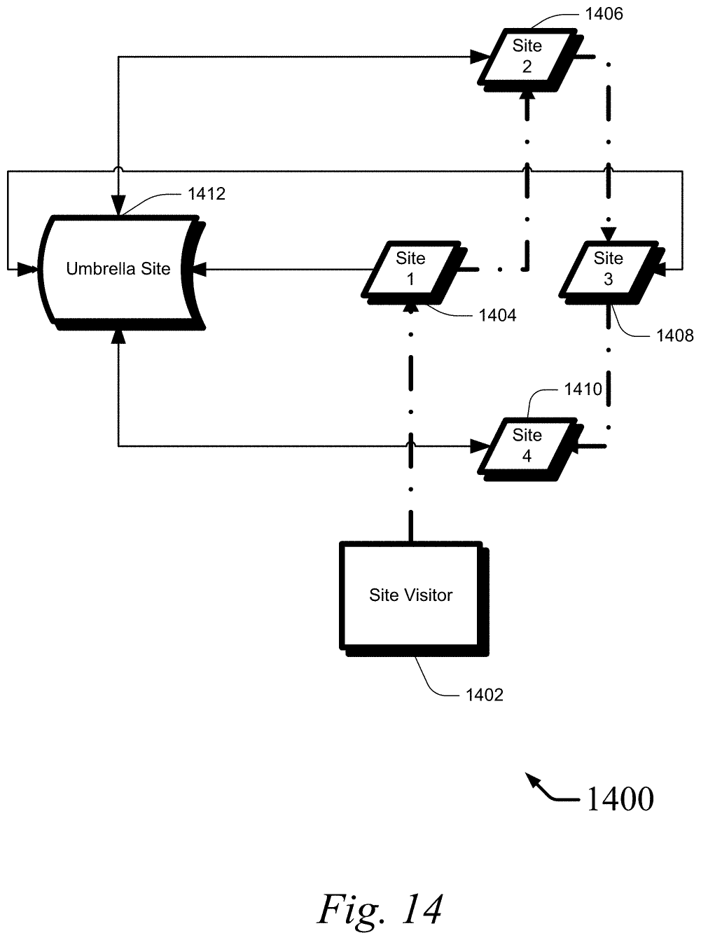

The user provides the initial request and this information is pushed to the umbrella site 1212, 1312, and 1412, as shown in FIGS. 12-14, where the umbrella site pushes the requested information back to the next merchant e-commerce website. If the user changes the requested information, such as is shown in FIG. 14, the information is updated for the rest of the user's shopping session so that the information is available over the network to be available to other merchant e-commerce websites. This feature ensures that the user's experience in the network of merchant e-commerce websites is enhanced and provides the user with a personalized experience.

In FIG. 12, a customer 1202 visits merchant e-commerce website 1204. The customer 1202 requests Information from merchant e-commerce website 1204 which is pushed by merchant e-commerce website 1204 to umbrella site 1212. The Customer 1202 thereafter visits merchant e-commerce website 1206 where merchant e-commerce website 1206 requests information from umbrella site 1212.

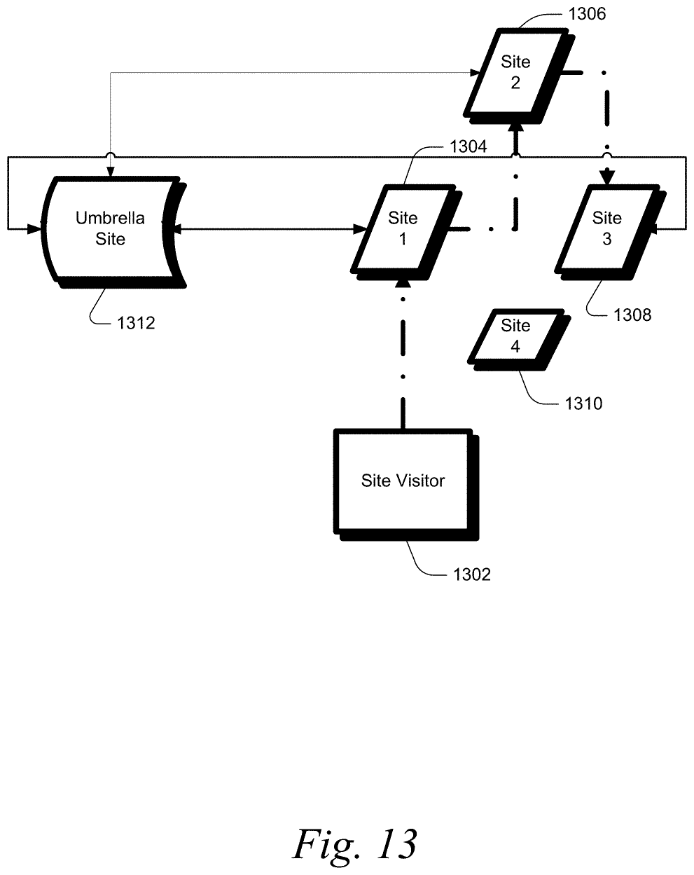

In FIG. 13, the customer 1302 visits merchant e-commerce website 1304 and requests information from merchant e-commerce website 1304 which merchant e-commerce website 1304 pushes to umbrella site 1312. The customer 1302 thereafter visits merchant e-commerce website 1306 and requests information from umbrella site 1312. The customer then visits merchant e-commerce website 1308 where merchant e-commerce website 1308 requests information from umbrella site 1312.

In FIG. 14, the customer 1402 visits merchant e-commerce website 1404 that merchant e-commerce website 1404 pushes information to umbrella site 1412. The customer 1402 then visits merchant e-commerce website 1406 where merchant e-commerce website 1406 requests information from umbrella site 1412. The customer 1402 then visits merchant e-commerce website 1408, where merchant e-commerce website 1408 requests information from umbrella site 1412. Note that customer 1402 could request new information while at merchant e-commerce website 1408, where merchant e-commerce website 1408 pushes request to umbrella site 1412. Thereafter, the customer 1402 visits site merchant e-commerce website 1410 where merchant e-commerce website 1410 requests information from umbrella site 1412 which is now related to the request from merchant e-commerce website 1408. In geo-fenced URL agnostic implementations, a comparison can be made between and general store and a specialty compilation store. In one implementation, a website visitor can access a single website that offers multiple categories and departments. In another implementation, a website visitor can access a plurality of websites each representing a department from a general store website, for example, where the visitor visits, in sequence, each of four (4) different websites each representing a department from a general store website.

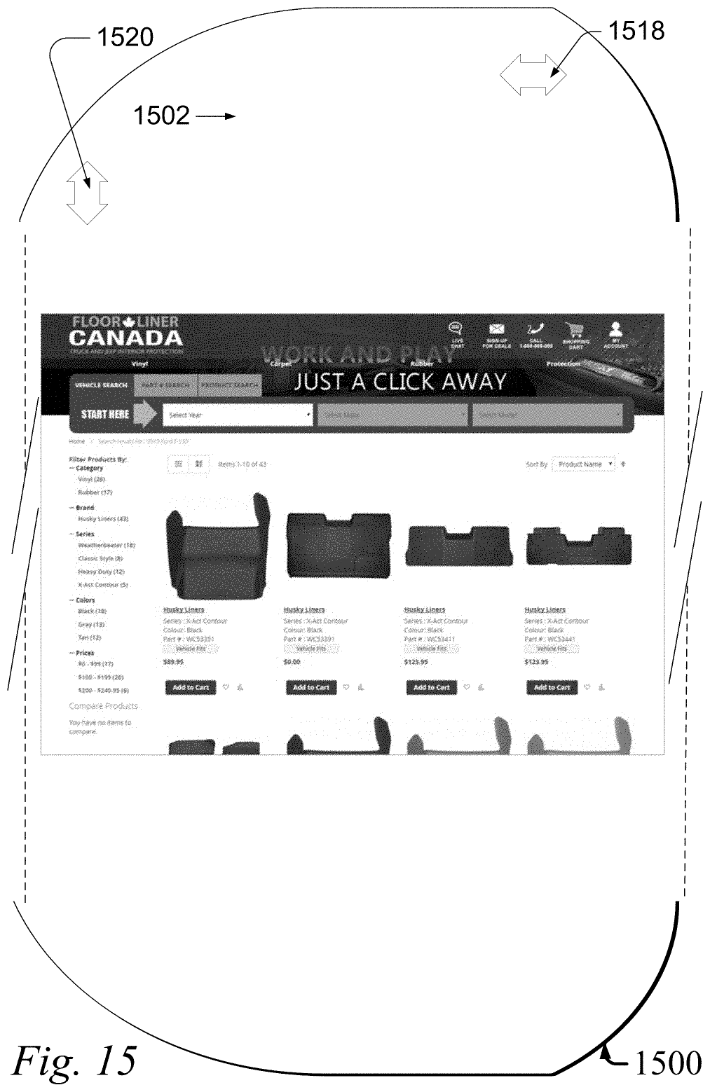

FIG. 15 shows a screen shot 1500 with a user interface for an automotive floor liner e-commerce website. By way of example, a customer inputs a search term pertaining only a vehicle type, such as by way of searching for “2010 Ford F-150”, such that when the customer 1402 visits merchant e-commerce website 1404 to shop for automotive floor liners, only those automobile floor liners for the “2010 Ford F-150” are offered to customer 1402 to put into the virtual shopping cart. Horizontal 1518 and vertical 1520 panning can be user activated to move that portion of the display that is being rendered horizontally and vertically, respectively.

In yet another implementation, a scientifically defined agnostic use is for a specific area or community would be providing consumers and merchants alike the opportunity to provide a heightened localized experience allowing them to support a local strip or destination mall. The purpose or usage of this application allows the merchants in a community that currently share a defined geographical area such as a strip mall to network together to provide an enhanced experience to the local community. This Merchant-Community Network provides a unique benefit to the consumers because they can target those customers in the region community. This targeted use over time will allow the Merchant-Network to enhance the experience and gather local data that can be leveraged to provide. In geo-fenced URL agnostic implementations, a comparison can be made to actual stores in a mall vs. the same stores in the same virtual mall. In a Mall/Store/Website Visitor implementation, each website is a store in a virtual mall. In Virtual Mall Visitor implementation, each website represents the same store in a virtual mall.

Various implementations enabled in this application reference concepts of community, including but not limited to a region, a local community, a community group, a community shopping region, and a geo-fenced shopping community, and a geographic community. These referenced implementations of community and the like, as used herein, are defined, characterized, and enabled in U.S. patent application Ser. No. 13/748,459, titled “Authorized Transaction Incented By Merchant Donation,” filed Jan. 23, 2013, and published May 15, 2014, as US Patent Application Publication No. US 2014/0136300A1, hereinafter the “Community Definition Reference”, which is incorporated herein by reference.

By way of example of one such implementation in the Community Definition Reference, a community is defined, characterized, and enabled as those merchants and account holders with whom the merchants conduct transactions that have respective physical addresses, where these physical addresses are used with a navigation time algorithm to determine the navigation time from the physical address of an account holder to the physical address of a merchant, where the determined navigation time is within a predetermined input minimum and a predetermined maximum navigation time for one or more transportation nodes, where the date and the date and time of a transaction between the account holder and the merchant are within a time period and day as provided by the merchant, and where the merchant and the account holder are deemed to be within the same community if the determined navigation travel time does not exceed a predetermined threshold.

By way of other example implementations in the Community Definition Reference, the merchant and a customer will not be determined to be in the same local community unless the respective physical addresses of merchant and customer are in the same community or neighborhood according to a predetermined algorithm. Any such local community determination can be made in any of several different methods, or combinations thereof, according to the merchant's preference as to what algorithm is mostly likely to attract the most favorable foot traffic to the merchant's brick and mortar store. One such method is a political or legal division, that is, the merchant's place of business is determined to be in the same political or legal division as that of its customer's residence, such as the same province, state, county, prefecture, city, city-state, borough, etc. Another such comparison can be whether the merchant's place of business has a governmentally issued postal code that is the same or within a predetermined proximity as that of its customer's residence. Yet another such comparison can be whether the merchant's place of business and its customer's residence are physically proximate within a predetermined factor by any of a variety of measures or combinations thereof. For example, latitude and longitude coordinates might be known for both the merchant's place of business and the residence of its customer. These coordinates can be used to determine whether the linear distance there between is within a predetermined distance to ascertain whether or not the merchant and its customer share the same local community.

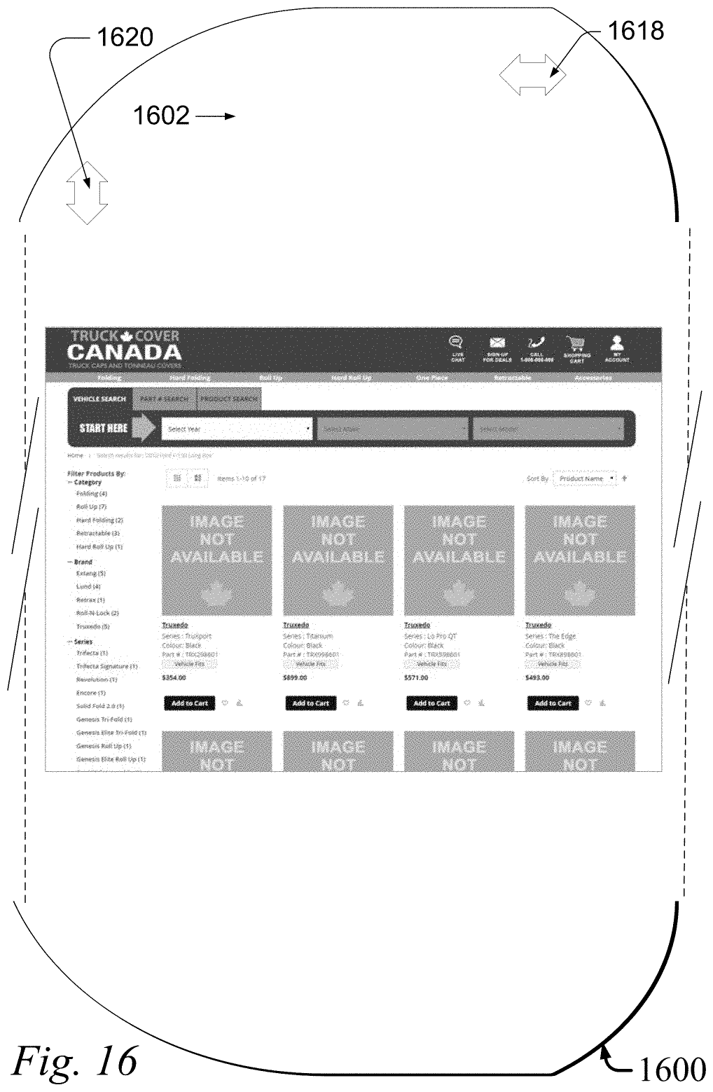

FIG. 16 shows a screen shot 1600, which is displayed to the customer after screen shot 1500, with a user interface for an automotive truck cover e-commerce website. By way of example, a customer inputs a search term pertaining only a vehicle type, such as by way of searching for “2010 Ford F-150”, such that when the customer 1402 visits merchant e-commerce website 1404 to shop for for automotive truck covers, only those automobile truck covers for the “2010 Ford F-150” are offered to customer 1402 to put into the virtual shopping cart. Horizontal 1618 and vertical 1120 panning can be user activated to move that portion of the display that is being rendered horizontally and vertically, respectively.

Referring now to “community”, which is to be understood as set forth in the Community Definition Reference, several implementations are now presented.

In geo-fenced URL agnostic implementations, a comparison can be made to a geographical community with stores and websites vs. a geographical community with a network of specialty websites to promote local buying from local merchants. In one implementation, the multi cart agnostic network allows for multiple uses and applications that can provide an improved localized experience. As defined by a physical address or postal code the agnostic application could provide the local users/customers to experience a specific range of sites that are applicable to the region/community they live, work and play in. These geographical engines allow the consumer to contribute to those stores that are physically located within the typical defined geographical region they consider to be the area/boundary they typically support and regularly shop as defined by a specific distance or time threshold from where they live or work. In a community shopping implementation, each store is represented in a geographic or community region. In a virtual community shopping implementation, each website can only be found in the same geographic or community region.

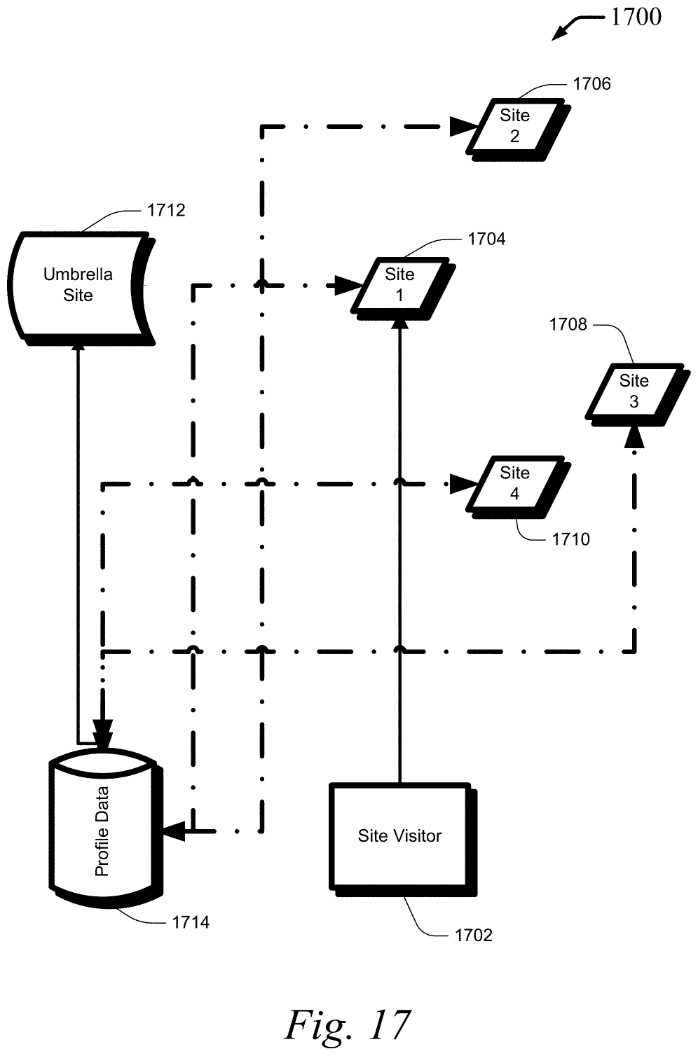

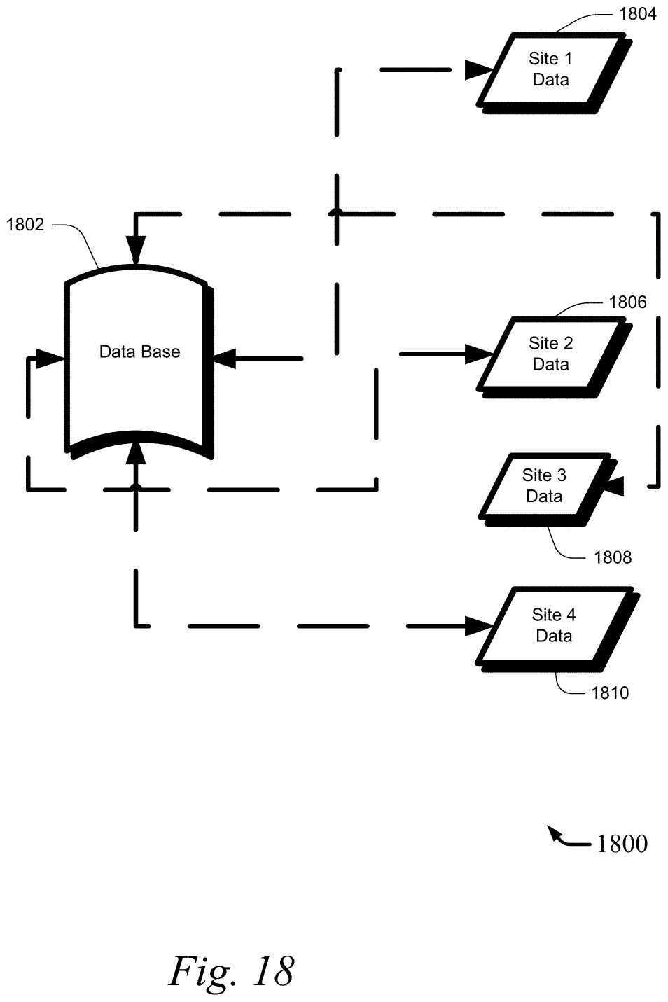

FIGS. 17-18 are flowcharts illustrating respective processes 1700, 1800 pertaining to a customer's ability to create information for, and allow the sharing of, a customer profile account. The information in the customer profile account can be shared over a network of merchant e-commerce websites. The customer's profile account information is shared with all of the connected merchant e-commerce websites to ensure each time the customer visits any merchant e-commerce website in the network, the customer will see and experience what they want, and when they want to see it. Preferably, the customer's profile account information will be securely contained and is pushed when requested by the customer as the customer visits and logs into any of the connected merchant e-commerce websites. The connecting of multiple specialty or boutique merchant e-commerce websites will thereby enhance the customer's internet experience. The shared information pertaining to the customer can include customer preferences, customer service preferences, customer billing preferences, customer freight preferences, standardized data that is to be re-used and re-purposed across all networked merchant e-commerce websites, and the use of plug-ins for social media that will track the customer's social interactions with the networked merchant e-commerce websites (e.g., tags, mentions).

In geo-fenced URL agnostic implementations, a community group, such as an organization life style community, may offer a network of specialty websites that are arranged so as to promote local buying and local purposes or interests. Each website in the accessible network is connected to a local cause, a local membership, and/or a local interest.

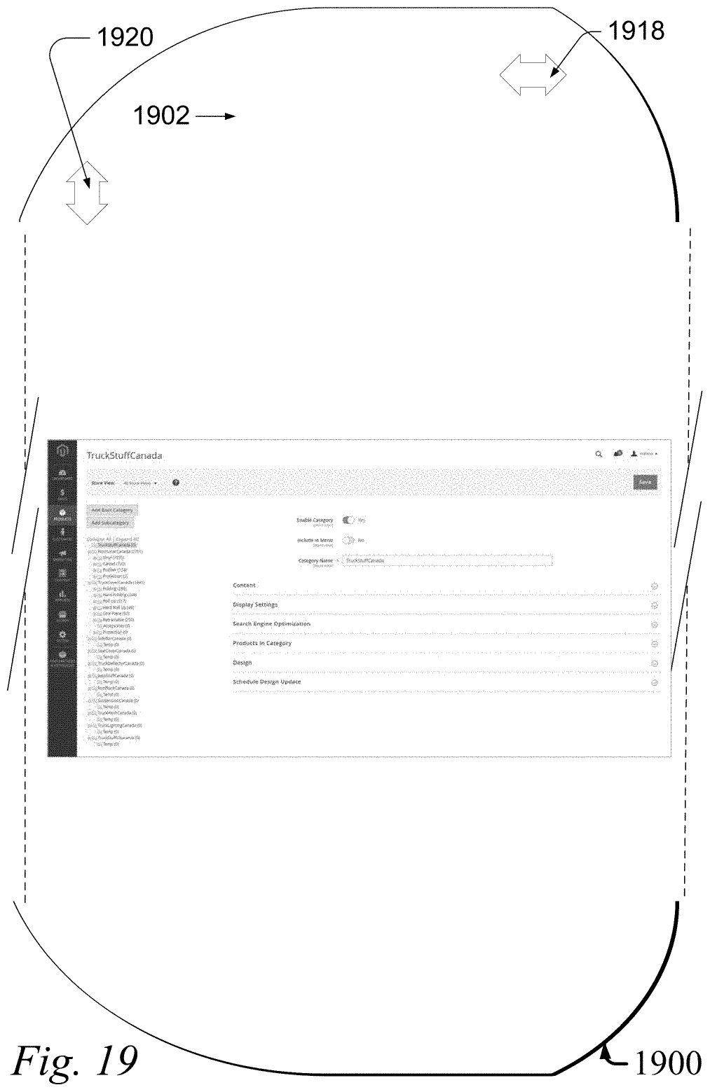

FIG. 19 shows a screen shot 1900 of a merchant e-commerce website that sells automotive goods and services characterized as “truck stuff”, where an umbrella website (e.g., see Reference Numeral 1412 in FIG. 14) helps with the administration data for the truck stuff merchant e-commerce website. Note, however, the truck stuff merchant e-commerce website can have its own data source and/or can share customer account profile information during a customer shopping session with other merchant e-commerce websites. Horizontal 1918 and vertical 1920 panning can be user activated to move that portion of the display that is being rendered horizontally and vertically, respectively.

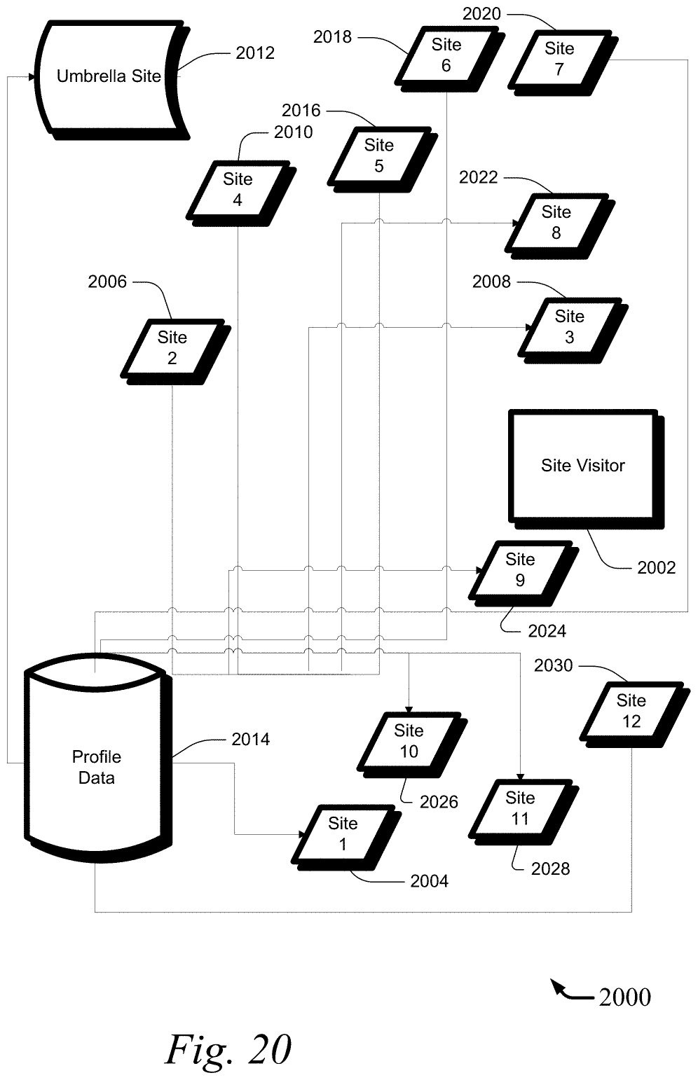

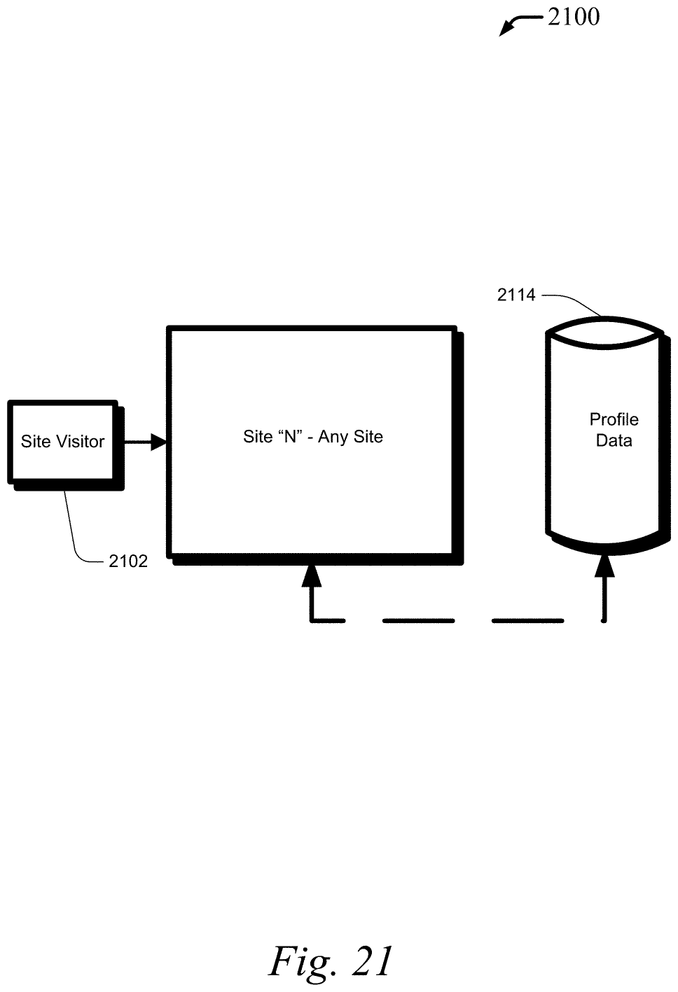

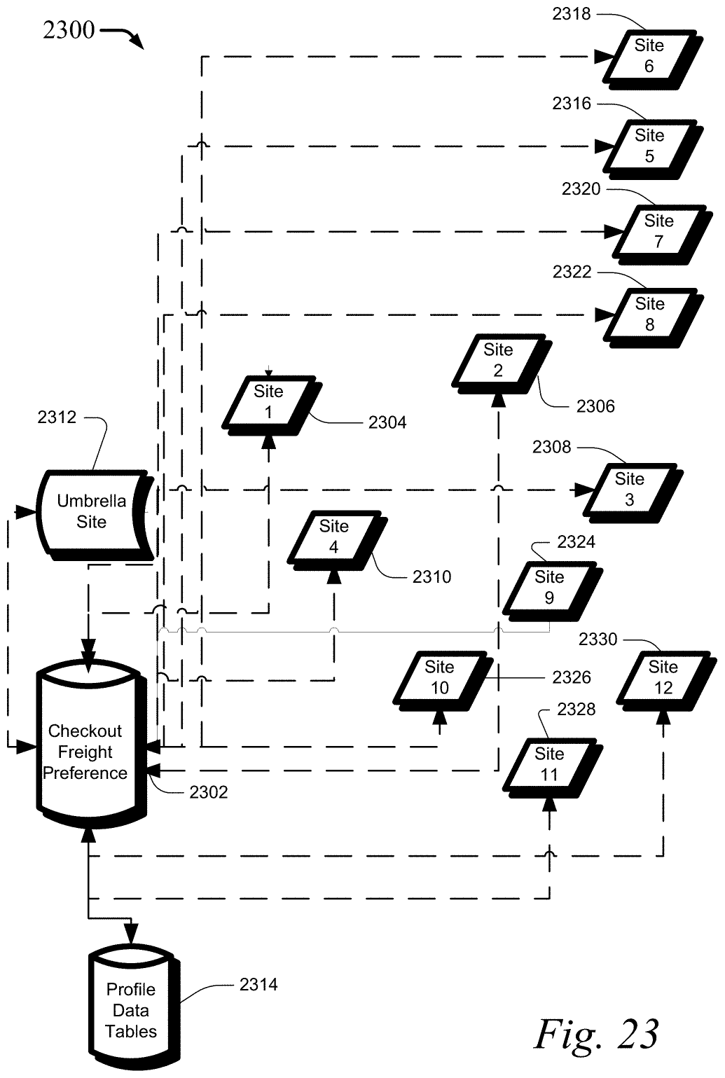

FIGS. 20-25 show flowcharts 2000, 2100, 2200, 2300, 2400 and 2500 illustrating respective processes for creating, accessing, and using information in customer profile accounts. As shown in FIGS. 20-21, customer profile data 2014, 2114 is kept in tables that can be used to store and gather customer information. The information in the customer profile data tables is gathered and retained for use by networked merchant e-commerce websites when the customer 2002, 2102 makes a future shopping visit. The information about the customer 2002, 2102 can be pushed into any of the entire networked merchant e-commerce websites 2004-2030 when requested, such as via umbrella site 2012, and can be accessed from any of the merchant e-commerce websites 2004-2030, thereby allowing the customer 2002, 2102 to enter any of the merchant e-commerce websites 2004-2030 and access information in the customer profile data 2014, 2114. The collection of different network connected merchant e-commerce websites 2004-2030 provides the customer with a personalized experience at any of the merchant e-commerce websites 2004-2030 so as to ensure that the customer sees those goods and services that the customer wants to see when the customer wants to see them. This concept provides customers with the fastest method of clicking and buying from any of the merchant e-commerce websites 2004-2030. As a customer modifies information in its customer profile data 2014, 2114, the customer's experience is enhanced and personalized, thereby making it more likely that the customer will spend more time shopping the collection of different network connected merchant e-commerce websites 2004-2030, where each connected merchant e-commerce website can use the modified information in customer profile data 2014, 2114 The value of shared data for both the user and the members of the umbrella site provides benefits for the member sites to compete with significantly larger sites that drive site traffic with significant ad word budgets and/or self-contained sites.

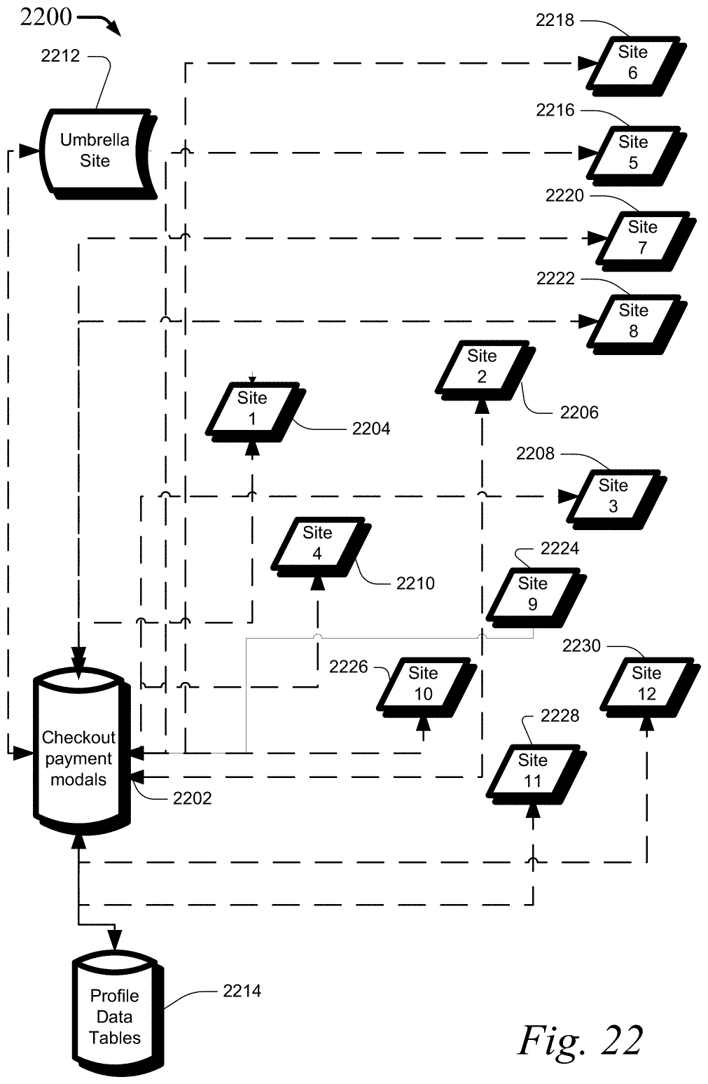

FIGS. 22-24 are flowcharts illustrating respective processes for a customer to shop a collection of different network connected merchant e-commerce websites 2204-2230, 2204-2230, 2404-2430 each of which has the use of information in customer profile data 2214, 2314, 2414. The customer account profile database can be used to allow the customer to provide information pertaining to the customer's preferred method of payment as shown in FIG. 22 at reference numeral 2202 so that the profile data will track and recognize the customer's preferred payment methods. When, in the future, the customer visits the collection of different network connected merchant e-commerce websites 2204-2230, 2204-2230, 2404-2430, the customer's profile will set the customer's preferred method of payment to the default method of payment, and can also take into account the customer's preferred type of freight company or method that best provides the customer comfort and security with the delivery of the customer's purchases. The profile data can be used to track and recognize the customer's preferred shipping methods such that, in the future, when the customer visits the collection of different network connected merchant e-commerce websites 2204-2230, 2204-2230, 2404-2430, the customer's profile will set the preferred method of shipping to the default method.

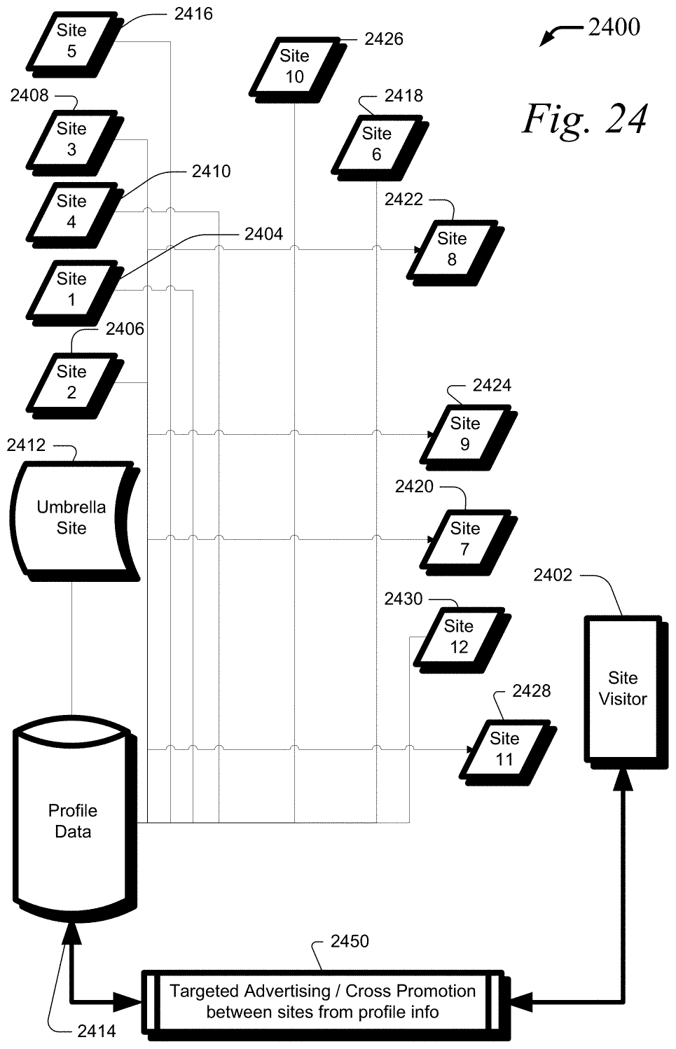

FIG. 24 shows flowchart 2400 illustrating a process for using information in a customer's account profile that can be gathered and shared between and among the collection of different network connected merchant e-commerce websites 2404-243. By using the customer's profile data along with other information gathered on the network, the collection of different network connected merchant e-commerce websites 2404-2430 can advertise and share information that is specific to the customer's interests. Having specific information in the profile data allows the information to be customized to the customer's interests and preferences. By way of example, if a customer's interests are limited only to “Ford Automobiles”, then the user interface would render only those goods and services offered for sale by the collection of different network connected merchant e-commerce websites 2304-2430 that are specifically related to goods, services, advertising, and messages of or relating to Ford Automobiles. Moreover, gathering, retention, modification, and use of the customer's profile data will allow the processes to track and recognize the customer's interests and allow for targeted advertising to be directed to the customer when shopping with the collection of different network connected merchant e-commerce websites 2304-2430.

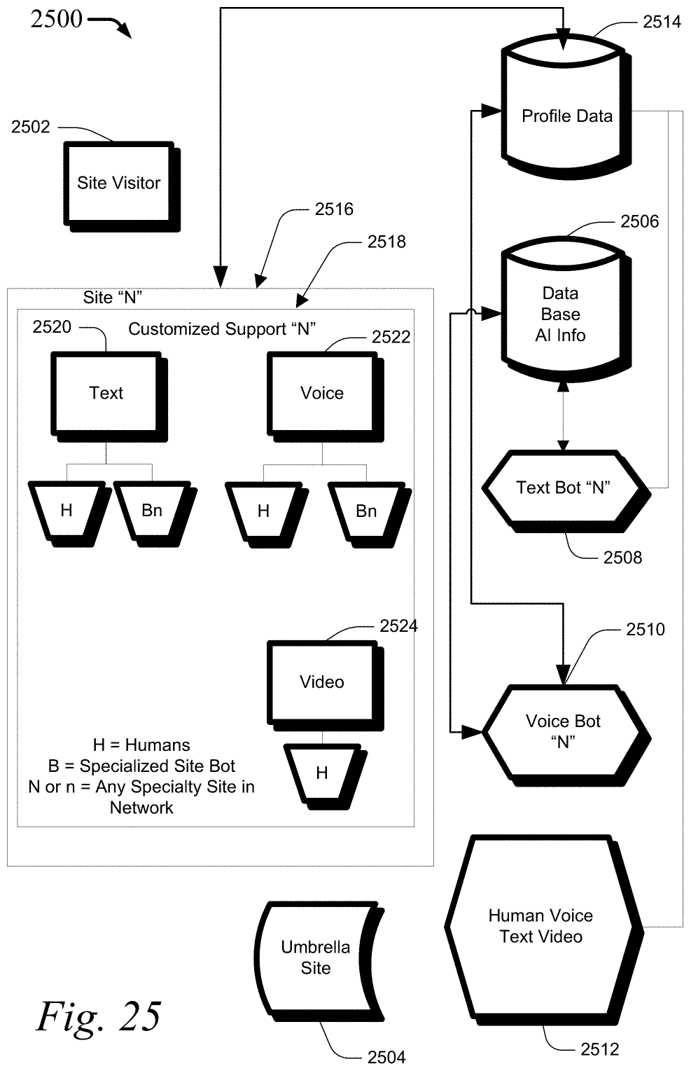

FIG. 25 shows a flowchart 2500 for a process in which information for a customer can be stored for subsequent sharing in profile data 2514 across a network of connected merchant e-commerce websites 1-N 2516. Each connected merchant e-commerce website (n) offers customized support 2518 by way of text functions 2520, voice functions 2522, and/or video functions 2524. Note that functions 2520-2524 can be enabled a human and/or robotically, and can be assisted via artificial intelligence using information in a network accessible database 2506. The associated and affiliated sites of the umbrella of sites will benefit significantly from this unique specialty site concept whereby they can participate with costly future web necessities such as artificial intelligence (AI).

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions. Moreover, a non-transient computer readable medium can include such software as instructions executed by hardware to perform steps of methods described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Tus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

What is claimed is:

1. A method comprising a plurality of steps each being performed by hardware executing software, wherein the steps include:
serving for delivery to a web browser corresponding to an e-commerce customer, for each of a plurality of received search terms, a virtual shopping cart and a webpage of a merchant e-commerce website, wherein the serving is performed such that the merchant e-commerce website served to the web browser logically corresponds to a merchant domain name that is limited to one of a plurality of different merchant domain names respectively and logically corresponding to other said merchant e-commerce websites that are logically associated, and in network communication, with an umbrella domain site;
retrieving, from the umbrella domain site, information pertaining to:
the e-commerce customer;
contents of the virtual shopping cart that includes a plurality of different items each sold by a different said merchant e-commerce website;
and
payment information pertaining to a payment received by only one said merchant domain name for an entirety of the contents of the virtual shopping cart from the e-commerce customer;
and
preparing, using the retrieved customer information, an invoice for the entirety of the contents of the virtual shopping cart, wherein the preparing is performed such that the invoice attributes a partial payment, derived from the payment information, to each of a plurality of merchants respectively corresponding each said item in the virtual shopping cart such that a sum of the partial payments equals to the payment received by the one said merchant domain name for the entirety of the contents of the virtual shopping cart.

2. The method as defined in claim 1, wherein each said item offered for sale at each said merchant e-commerce website is mutually exclusive to each said item offered for sale at each other said merchant e-commerce websites.

3. The method as defined in claim 1, wherein the umbrella domain site has a primary domain name of which the plurality of different merchant domain names are not subdomain names.

4. The method as defined in claim 1, wherein a sum of the partial payments equals the payment received by the one said merchant domain name for the entirety of the contents of the virtual shopping cart.

5. The method as defined in claim 1, wherein:
the e-commerce customer is associated with a physical address stored as network accessible information stored in the umbrella domain site;
each said merchant domain name corresponds to a merchant associated with a physical address stored as network accessible information stored in the umbrella domain site;
and
the serving further comprises:
for each of the plurality of received search terms:
comparing the received search term to metadata associated with the plurality of different merchant domain names;
and
when:
the received search term matches the metadata associated with one said merchant e-commerce website, then accessing the umbrella domain site to retrieve the respective physical addresses of the e-commerce customer and the merchant corresponding to the matching one said merchant e-commerce website;
and
when the respective physical addresses of the e-commerce customer and the merchant corresponding to the matching one said merchant e-commerce website are determined to be located within a same community by a predetermined community definition, then serving for delivery to the web browser corresponding to the e-commerce customer the matching said webpage of the merchant e-commerce website.

6. A method comprising a plurality of steps each being performed by hardware executing software, wherein the steps include:
serving for delivery to a web browser corresponding to an e-commerce customer, for each of a plurality of received search terms, a virtual shopping cart and a webpage of a merchant e-commerce website, wherein the serving is performed such that:
the merchant e-commerce website served to the web browser logically corresponds to a merchant domain name that is limited to one of a plurality of different merchant domain names respectively and logically corresponding to the other said merchant e-commerce websites that are logically associated, and in network communication, with an umbrella domain site having a primary domain name of which the plurality of different merchant domain names are not subdomain names; and
each said merchant e-commerce website offers for sale items mutually exclusive to items offered for sale by the other said merchant e-commerce websites;
retrieving, from the umbrella domain site, information pertaining to:
the e-commerce customer;
contents of the virtual shopping cart that includes a plurality of different items each sold by a different said merchant e-commerce website;
and
payment information pertaining to a payment received by only one said merchant domain name for an entirety of the contents of the virtual shopping cart from the e-commerce customer;
and
preparing, using the retrieved customer information, an invoice for the entirety of the contents of the virtual shopping cart, wherein the preparing is performed such that the invoice attributes a partial payment, derived from the payment information, to each of a plurality of merchants respectively corresponding each said item in the virtual shopping cart such that a sum of the partial payments equals to the payment received by the one said merchant domain name for the entirety of the contents of the virtual shopping cart.

7. The method as defined in claim 6, wherein:
the e-commerce customer is associated with a physical address stored as network accessible information stored in the umbrella domain site;
each said merchant domain name corresponds to a merchant associated with a physical address stored as network accessible information stored in the umbrella domain site;
and
the serving further comprises:
for each of the plurality of received search terms:
comparing the received search term to metadata associated with the plurality of different merchant domain names;
and
when:
the received search term matches the metadata associated with one said merchant e-commerce website, then accessing the umbrella domain site to retrieve the respective physical addresses of the e-commerce customer and the merchant corresponding to the matching one said merchant e-commerce website;
and
when the respective physical addresses of the e-commerce customer and the merchant corresponding to the matching one said merchant e-commerce website are determined to be located within a same community by a predetermined community definition, then serving for delivery to the web browser corresponding to the e-commerce customer the matching said webpage of the merchant e-commerce website.

8. The method as defined in claim 7, wherein the predetermined community definition is that the respective physical addresses of the e-commerce customer and the merchant corresponding to the matching one said merchant e-commerce website are within the same governmentally issued postal code.

9. The method as defined in claim 7, wherein the predetermined community definition is that the respective physical addresses of the e-commerce customer and the merchant corresponding to the matching one said merchant e-commerce website are within the same political or legal division selected from the group consisting of a province, state, county, prefecture, city, city-state, and borough.

10. The method as defined in claim 7, wherein the predetermined community definition is that the respective physical addresses of the e-commerce customer and the merchant corresponding to the matching one said merchant e-commerce website are separated by a distance navigable by a predetermined transportation mode within a predetermined maximum navigation time as determined by a predetermined a navigation time algorithm.

11. The method as defined in claim 6, wherein each said item offered for sale at each said merchant e-commerce website is mutually exclusive to each said item offered for sale at each other said merchant e-commerce websites.

12. The method as defined in claim 6, wherein the umbrella domain site has a primary domain name of which the plurality of different merchant domain names are not subdomain names.

13. The method as defined in claim 6, wherein a sum of the partial payments equals the payment received by the one said merchant domain name for the entirety of the contents of the virtual shopping cart.

14. A method comprising a plurality of steps each being performed by hardware executing software, wherein the steps include:
for each of the plurality of received search terms, comparing the received search term to metadata associated with a plurality of different merchant domain names respectively and logically corresponding to other said merchant e-commerce websites that are logically associated, and in network communication, with an umbrella domain site having a primary domain name of which the plurality of different merchant domain names are not subdomain names;
when the received search term matches the metadata associated with one said merchant e-commerce website, then:
accessing the umbrella domain site to retrieve the respective physical addresses of the e-commerce customer and the merchant corresponding to the matching one said merchant e-commerce website; and
when the respective physical addresses of the e-commerce customer and the merchant corresponding to the matching one said merchant e-commerce website are determined to be located within a same community by a predetermined community definition that the respective physical addresses of the e-commerce customer and the merchant corresponding to the matching one said merchant e-commerce website are separated by a distance navigable by a predetermined transportation mode within a predetermined maximum navigation time as determined by a predetermined a navigation time algorithm, then:
serving, for delivery to a web browser corresponding to an e-commerce customer, a virtual shopping cart and a webpage of the matching one said merchant e-commerce website, wherein the serving is performed such that each said merchant e-commerce website offers for sale items mutually exclusive to items offered for sale by other said merchant e-commerce websites;
retrieving, from the umbrella domain site, information pertaining to:
the e-commerce customer;
contents of the virtual shopping cart that includes a plurality of different items each sold by a different said merchant e-commerce website;
and
payment information pertaining to a payment received by only one said merchant domain name for an entirety of the contents of the virtual shopping cart from the e-commerce customer;
and
preparing, using the retrieved customer information, an invoice for the entirety of the contents of the virtual shopping cart, wherein the preparing is performed such that the invoice attributes a partial payment, derived from the payment information, to each of a plurality of merchants respectively corresponding each said item in the virtual shopping cart such that a sum of the partial payments equals to the payment received by the one said merchant domain name for the entirety of the contents of the virtual shopping cart.

15. The method as defined in claim 14, wherein the predetermined community definition is that the respective physical addresses of the e-commerce customer and the merchant corresponding to the matching one said merchant e-commerce website are within the same governmentally issued postal code.

16. The method as defined in claim 14, wherein the predetermined community definition is that the respective physical addresses of the e-commerce customer and the merchant corresponding to the matching one said merchant e-commerce website are within the same political or legal division selected from the group consisting of a province, state, county, prefecture, city, city-state, and borough.

17. The method as defined in claim 14, wherein the predetermined community definition is that the respective physical addresses of the e-commerce customer and the merchant corresponding to the matching one said merchant e-commerce website are separated by a distance navigable by a predetermined transportation mode within a predetermined maximum navigation time as determined by a predetermined a navigation time algorithm.

18. The method as defined in claim 14, wherein each said item offered for sale at each said merchant e-commerce website is mutually exclusive to each said item offered for sale at each other said merchant e-commerce websites.

19. The method as defined in claim 14, wherein the umbrella domain site has a primary domain name of which the plurality of different merchant domain names are not subdomain names.

20. The method as defined in claim 14, wherein a sum of the partial payments equals the payment received by the one said merchant domain name for the entirety of the contents of the virtual shopping cart.
